(19) United States
(12) Patent Application Publication
(10) Pub. No.: US 2021/0092069 A1
(43) Pub. Date: Mar. 25, 2021

(54) ACCELERATING MULTI-NODE PERFORMANCE OF MACHINE LEARNING WORKLOADS

(71) Applicant: Intel Corporation, Santa Clara, CA (US)

(72) Inventors: Malek MUSLEH, Portland, OR (US); Anupama KURPAD, Portland, OR (US); Roberto PENARANDA CEBRIAN, Santa Clara, CA (US); Allister ALEMANIA, North Plains, OR (US); Pedro YEBENES SEGURA, San Jose, CA (US); Curt E. BRUNS, Gilbert, AZ (US); Robert SOUTHWORTH, Chatsworth, CA (US); Sujoy SEN, Beaverton, OR (US)

(21) Appl. No.: 17/118,409

(22) Filed: Dec. 10, 2020

(51) Int. Cl. H04L 12/851; H04L 12/751; H04L 12/853; H04L 12/727; G06N 3/08; G06N 3/04

(52) U.S. Cl. CPC H04L 47/2441; H04L 45/08; G06N 3/04; H04L 45/121; G06N 3/084; H04L 47/2416

(57) ABSTRACT

Examples described herein relate to a network interface and at least one processor that is to indicate whether data is associated with a machine learning operation or non-machine learning operation to manage traversal of the data through one or more network elements to a destination network element and cause the network interface to include an indication in a packet of whether the packet includes machine learning data or non-machine learning data. In some examples, the indication in a packet of whether the packet includes machine learning data or non-machine learning data comprises a priority level and wherein one or more higher priority levels identify machine learning data. In some examples, for machine learning data, the priority level is based on whether the data is associated with inference, training, or re-training operations. In some examples, for machine learning data, the priority level is based on whether the data is associated with real-time or time insensitive inference operations.

Data center networks (DCNs) and edge and fog computing elements continue to experience an explosion in growth as market trends indicate an increase in cloud usage involving an ever-increasing amount of data. More specifically, the growth in DCN network traffic is fueled, in part, by pervasive use of data-intensive usage models involving artificial intelligence (AI) and machine learning (ML) in the cloud.

### BRIEF DESCRIPTION OF THE DRAWINGS

FIG. 1 is a block diagram of a processing system according to an embodiment.

FIGS. 2A-2D illustrate computing systems and graphics processors provided by embodiments described herein.

FIGS. 3A-3C illustrate block diagrams of additional graphics processor and compute accelerator architectures provided by embodiments described herein.

FIG. 4 is a block diagram of a graphics processing engine of a graphics processor in accordance with some embodiments.

FIGS. 5A-5B illustrate thread execution logic including an array of processing elements employed in a graphics processor core according to embodiments described herein.

FIG. 6 illustrates an additional execution unit, according to an embodiment.

FIG. 7 is a block diagram illustrating a graphics processor instruction formats according to some embodiments.

FIG. 8 is a block diagram of another embodiment of a graphics processor.

FIG. 9A is a block diagram illustrating a graphics processor command format according to some embodiments.

FIG. 9B is a block diagram illustrating a graphics processor command sequence according to an embodiment.

FIG. 10 illustrates an exemplary graphics software architecture for a data processing system according to some embodiments.

FIG. 11A is a block diagram illustrating an IP core development system that may be used to manufacture an integrated circuit to perform operations according to an embodiment.

FIG. 11B illustrates a cross-section side view of an integrated circuit package assembly, according to some embodiments described herein.

FIG. 11C illustrates a package assembly that includes multiple units of hardware logic chiplets connected to a substrate.

FIG. 11D illustrates a package assembly including interchangeable chiplets, according to an embodiment.

FIGS. 12, 13A and 13B illustrate exemplary integrated circuits and associated graphics processors that may be fabricated using one or more IP cores, according to various embodiments described herein.

FIG. 14 depicts an example of a neural network.

FIG. 15 depicts an example of data-parallelism.

FIG. 16 depicts an example of model parallelism.

FIG. 17 provides an illustration of communication dependency for forward and backward propagation communication for a data-parallel Deep Learning workload.

FIG. 18 depicts an overview of various embodiments.

FIG. 19A depicts an example packet header format.

FIG. 19B provides an illustration of prioritization.

FIG. 20 depicts an example of adaptive routing applied to a flow's packets in the presence of network congestion that will cause flow to miss specified deadline.

FIG. 21 depicts an example of packet monitoring queues.

FIG. 22 depicts an example of parameters of a neural network.

FIG. 23 shows examples of assigning priorities to layers based on weighing characteristics of a neural network.

FIG. 24 depicts an example manner to assign message priority.

FIG. 25A depicts an example process.

FIG. 25B depicts an example process.

FIG. 26 depicts an example network interface.

FIG. 27 depicts a system.

FIG. 28 depicts an example environment.

### DETAILED DESCRIPTION

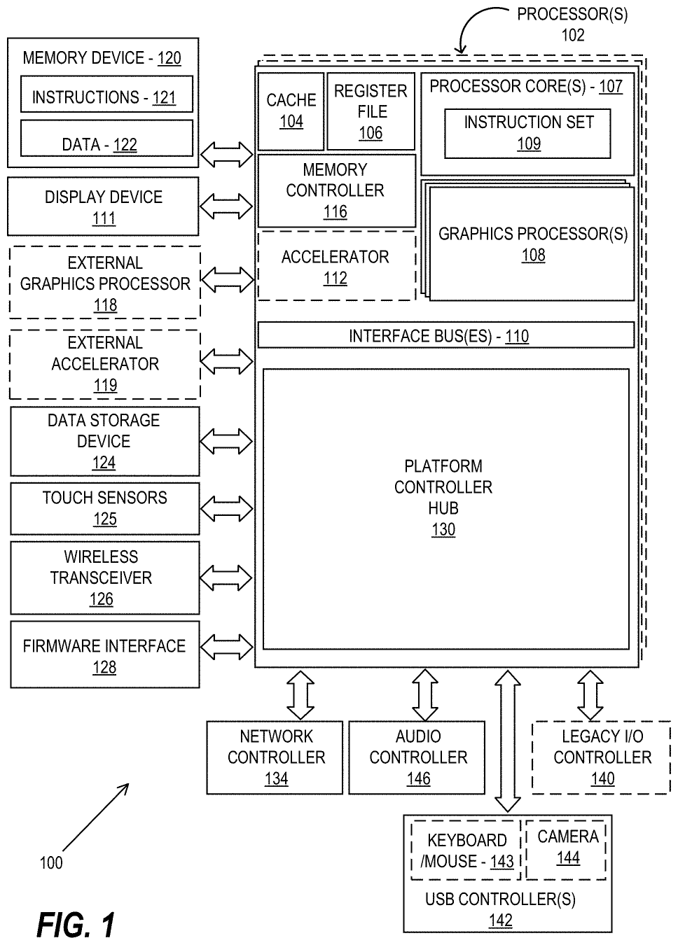

FIG. 1 is a block diagram of a processing system 100, according to an embodiment. System 100 may be used in a single processor desktop system, a multiprocessor workstation system, or a server system having a large number of processors 102 or processor cores 107. In one embodiment, the system 100 is a processing platform incorporated within a system-on-a-chip (SoC) integrated circuit for use in mobile, handheld, or embedded devices such as within Internet-of-things (IoT) devices with wired or wireless connectivity to a local or wide area network.

In one embodiment, system 100 can include, couple with, or be integrated within: a server-based gaming platform; a game console, including a game and media console; a mobile gaming console, a handheld game console, or an online game console. In some embodiments the system 100 is part of a mobile phone, smart phone, tablet computing device or mobile Internet-connected device such as a laptop with low internal storage capacity. Processing system 100 can also include, couple with, or be integrated within: a wearable device, such as a smart watch wearable device; smart eyewear or clothing enhanced with augmented reality (AR) or virtual reality (VR) features to provide visual, audio or tactile outputs to supplement real world visual, audio or tactile experiences or otherwise provide text, audio, graphics, video, holographic images or video, or tactile feedback; other augmented reality (AR) device; or other virtual reality (VR) device. In some embodiments, the processing system 100 includes or is part of a television or set top box device. In one embodiment, system 100 can include, couple with, or be integrated within a self-driving vehicle such as a bus, tractor trailer, car, motor or electric power cycle, plane or glider (or any combination thereof). The self-driving vehicle may use system 100 to process the environment sensed around the vehicle.

In some embodiments, the one or more processors 102 each include one or more processor cores 107 to process instructions which, when executed, perform operations for system or user software. In some embodiments, at least one of the one or more processor cores 107 is configured to process a specific instruction set 109. In some embodiments, instruction set 109 may facilitate Complex Instruction Set Computing (CISC), Reduced Instruction Set Computing (RISC), or computing via a Very Long Instruction Word (VLIW). One or more processor cores 107 may process a different instruction set 109, which may include instructions to facilitate the emulation of other instruction sets. Processor core 107 may also include other processing devices, such as a Digital Signal Processor (DSP).

In some embodiments, the processor 102 includes cache memory 104. Depending on the architecture, the processor 102 can have a single internal cache or multiple levels of internal cache. In some embodiments, the cache memory is shared among various components of the processor 102. In some embodiments, the processor 102 also uses an external cache (e.g., a Level-3 (L3) cache or Last Level Cache (LLC)) (not shown), which may be shared among processor cores 107 using known cache coherency techniques. A register file 106 can be additionally included in processor 102 and may include different types of registers for storing different types of data (e.g., integer registers, floating point registers, status registers, and an instruction pointer register). Some registers may be general-purpose registers, while other registers may be specific to the design of the processor 102.

In some embodiments, one or more processor(s) 102 are coupled with one or more interface bus(es) 110 to transmit communication signals such as address, data, or control signals between processor 102 and other components in the system 100. The interface bus 110, in one embodiment, can be a processor bus, such as a version of the Direct Media Interface (DMI) bus. However, processor busses are not limited to the DMI bus, and may include one or more Peripheral Component Interconnect buses (e.g., PCI, PCI express), memory busses, or other types of interface busses. In one embodiment the processor(s) 102 include an integrated memory controller 116 and a platform controller hub 130. The memory controller 116 facilitates communication between a memory device and other components of the system 100, while the platform controller hub (PCH) 130 provides connections to I/O devices via a local I/O bus.

The memory device 120 can be a dynamic random-access memory (DRAM) device, a static random-access memory (SRAM) device, flash memory device, phase-change memory device, or some other memory device having suitable performance to serve as process memory. In one embodiment the memory device 120 can operate as system memory for the system 100, to store data 122 and instructions 121 for use when the one or more processors 102 executes an application or process. Memory controller 116 also couples with an optional external graphics processor 118, which may communicate with the one or more graphics processors 108 in processors 102 to perform graphics and media operations. In some embodiments, graphics, media, and or compute operations may be assisted by an accelerator 112 which is a coprocessor that can be configured to perform a specialized set of graphics, media, or compute operations. For example, in one embodiment the accelerator 112 is a matrix multiplication accelerator used to optimize machine learning or compute operations. In one embodiment the accelerator 112 is a ray-tracing accelerator that can be used to perform ray-tracing operations in concert with the graphics processor 108. In one embodiment, an external accelerator 119 may be used in place of or in concert with the accelerator 112.

In some embodiments a display device 111 can connect to the processor(s) 102. The display device 111 can be one or more of an internal display device, as in a mobile electronic device or a laptop device or an external display device attached via a display interface (e.g., DisplayPort, embedded DisplayPort, MIPI, HDMI, etc.). In one embodiment the display device 111 can be a head mounted display (HMD) such as a stereoscopic display device for use in virtual reality (VR) applications or augmented reality (AR) applications.

In some embodiments the platform controller hub 130 enables peripherals to connect to memory device 120 and processor 102 via a high-speed I/O bus. The I/O peripherals include, but are not limited to, an audio controller 146, a network controller 134, a firmware interface 128, a wireless transceiver 126, touch sensors 125, a data storage device 124 (e.g., non-volatile memory, volatile memory, hard disk drive, flash memory, NAND, 3D NAND, 3D XPoint, etc.). The data storage device 124 can connect via a storage interface (e.g., SATA) or via a peripheral bus, such as a Peripheral Component Interconnect bus (e.g., PCI, PCI express). The touch sensors 125 can include touch screen sensors, pressure sensors, or fingerprint sensors. The wireless transceiver 126 can be a Wi-Fi transceiver, a Bluetooth transceiver, or a mobile network transceiver such as a 3G, 4G, 5G, or Long-Term Evolution (LTE) transceiver. The firmware interface 128 enables communication with system firmware, and can be, for example, a unified extensible firmware interface (UEFI). The network controller 134 can enable a network connection to a wired network. In some embodiments, a high-performance network controller (not shown) couples with the interface bus 110. The audio controller 146, in one embodiment, is a multi-channel high definition audio controller. In one embodiment the system 100 includes an optional legacy I/O controller 140 for coupling legacy (e.g., Personal System 2 (PS/2)) devices to the system. The platform controller hub 130 can also connect to one or more Universal Serial Bus (USB) controllers 142 connect input devices, such as keyboard and mouse 143 combinations, a camera 144, or other USB input devices.

It will be appreciated that the system 100 shown is exemplary and not limiting, as other types of data processing systems that are differently configured may also be used. For example, an instance of the memory controller 116 and platform controller hub 130 may be integrated into a discreet external graphics processor, such as the external graphics processor 118. In one embodiment the platform controller hub 130 and/or memory controller 116 may be external to the one or more processor(s) 102. For example, the system 100 can include an external memory controller 116 and platform controller hub 130, which may be configured as a memory controller hub and peripheral controller hub within a system chipset that is in communication with the processor(s) 102.

For example, circuit boards (“sleds”) can be used on which components such as CPUs, memory, and other components are placed are designed for increased thermal performance. In some examples, processing components such as the processors are located on a top side of a sled while near memory, such as DIMMs, are located on a bottom side of the sled. As a result of the enhanced airflow provided by this design, the components may operate at higher frequencies and power levels than in typical systems, thereby increasing performance. Furthermore, the sleds are configured to blindly mate with power and data communication cables in a rack, thereby enhancing their ability to be quickly removed, upgraded, reinstalled, and/or replaced. Similarly, individual components located on the sleds, such as processors, accelerators, memory, and data storage drives, are configured to be easily upgraded due to their increased spacing from each other. In the illustrative embodiment, the components additionally include hardware attestation features to prove their authenticity.

A data center can utilize a single network architecture (“fabric”) that supports multiple other network architectures including Ethernet and Omni-Path. The sleds can be coupled to switches via optical fibers, which provide higher bandwidth and lower latency than typical twisted pair cabling (e.g., Category 5, Category 5e, Category 6, etc.). Due to the high bandwidth, low latency interconnections and network architecture, the data center may, in use, pool resources, such as memory, accelerators (e.g., GPUs, graphics accelerators, FPGAs, ASICs, neural network and/or artificial intelligence accelerators, etc.), and data storage drives that are physically disaggregated, and provide them to compute resources (e.g., processors) on an as needed basis, enabling the compute resources to access the pooled resources as if they were local.

A power supply or source can provide voltage and/or current to system 100 or any component or system described herein. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

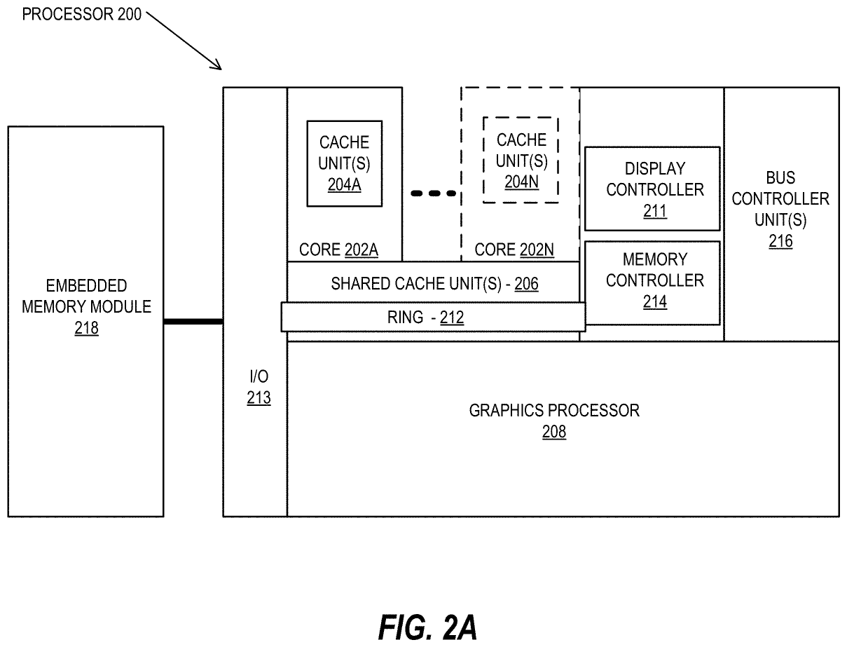

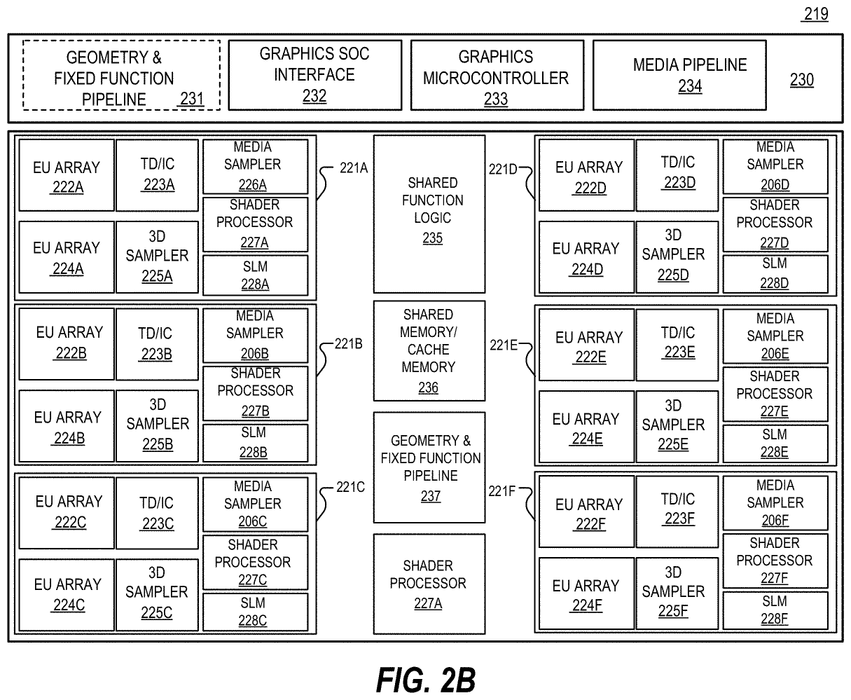

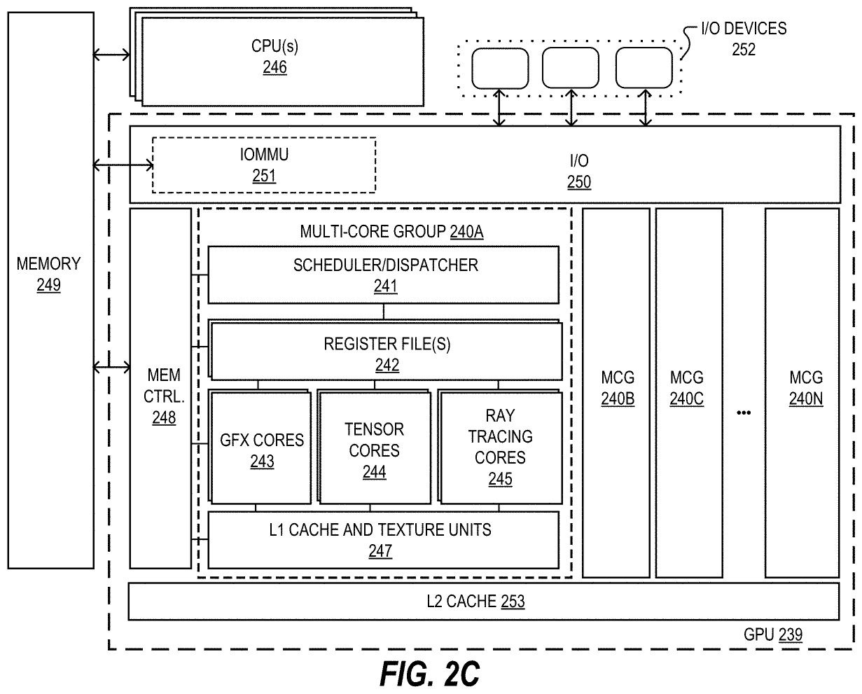

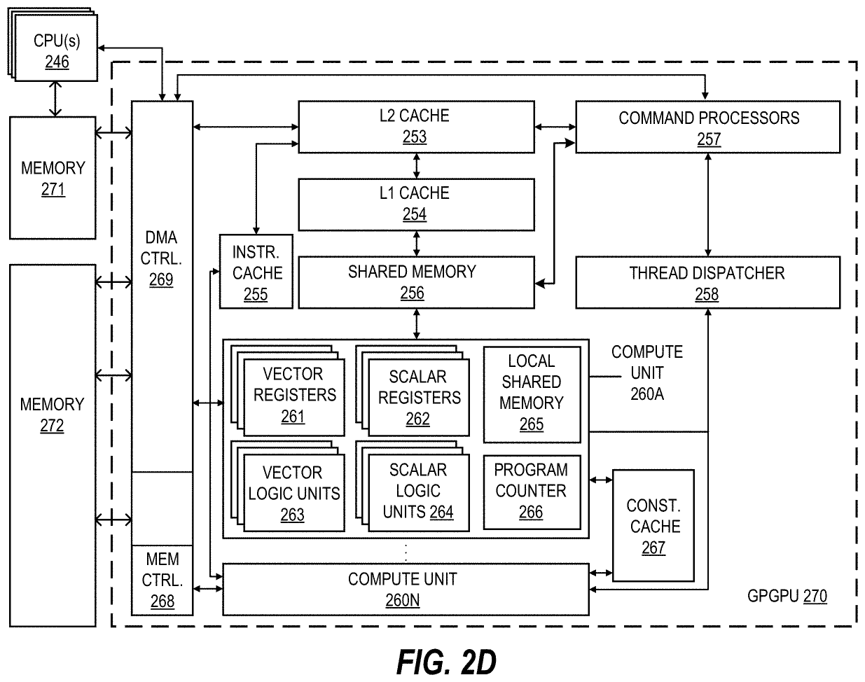

FIGS. 2A-2D illustrate computing systems and graphics processors provided by embodiments described herein. The elements of FIGS. 2A-2D having the same reference numbers (or names) as the elements of any other figure herein can operate or function in any manner similar to that described elsewhere herein, but are not limited to such.

FIG. 2A is a block diagram of an embodiment of a processor 200 having one or more processor cores 202A-202N, an integrated memory controller 214, and an integrated graphics processor 208. Processor 200 can include additional cores up to and including additional core 202N represented by the dashed lined boxes. Each of processor cores 202A-202N includes one or more internal cache units 204A-204N. In some embodiments each processor core also has access to one or more shared cached units 206. The internal cache units 204A-204N and shared cache units 206 represent a cache memory hierarchy within the processor 200. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 206 and 204A-204N.

In some embodiments, processor 200 may also include a set of one or more bus controller units 216 and a system agent core 210. The one or more bus controller units 216 manage a set of peripheral buses, such as one or more PCI or PCI express busses. System agent core 210 provides management functionality for the various processor components. In some embodiments, system agent core 210 includes one or more integrated memory controllers 214 to manage access to various external memory devices (not shown).

In some embodiments, one or more of the processor cores 202A-202N include support for simultaneous multi-threading. In such embodiment, the system agent core 210 includes components for coordinating and operating cores 202A-202N during multi-threaded processing. System agent core 210 may additionally include a power control unit (PCU), which includes logic and components to regulate the power state of processor cores 202A-202N and graphics processor 208.

In some embodiments, processor 200 additionally includes graphics processor 208 to execute graphics processing operations. In some embodiments, the graphics processor 208 couples with the set of shared cache units 206, and the system agent core 210, including the one or more integrated memory controllers 214. In some embodiments, the system agent core 210 also includes a display controller 211 to drive graphics processor output to one or more coupled displays. In some embodiments, display controller 211 may also be a separate module coupled with the graphics processor via at least one interconnect, or may be integrated within the graphics processor 208.

In some embodiments, a ring-based interconnect unit 212 is used to couple the internal components of the processor 200. However, an alternative interconnect unit may be used, such as a point-to-point interconnect, a switched interconnect, or other techniques, including techniques well known in the art. In some embodiments, graphics processor 208 couples with the ring interconnect 212 via an I/O link 213.

The exemplary I/O link 213 represents at least one of multiple varieties of I/O interconnects, including an on package I/O interconnect which facilitates communication between various processor components and a high-performance embedded memory module 218, such as an eDRAM module. In some embodiments, each of the processor cores 202A-202N and graphics processor 208 can use embedded memory modules 218 as a shared Last Level Cache.

In some embodiments, processor cores 202A-202N are homogenous cores executing the same instruction set architecture. In another embodiment, processor cores 202A-202N are heterogeneous in terms of instruction set architecture (ISA), where one or more of processor cores 202A-202N execute a first instruction set, while at least one of the other cores executes a subset of the first instruction set or a different instruction set. In one embodiment, processor cores 202A-202N are heterogeneous in terms of microarchitecture, where one or more cores having a relatively higher power consumption couple with one or more power cores having a lower power consumption. In one embodiment, processor cores 202A-202N are heterogeneous in terms of computational capability. Additionally, processor 200 can be implemented on one or more chips or as an SoC integrated circuit having the illustrated components, in addition to other components.

FIG. 2B is a block diagram of hardware logic of a graphics processor core 219, according to some embodiments described herein. Elements of FIG. 2B having the same reference numbers (or names) as the elements of any other figure herein can operate or function in any manner similar to that described elsewhere herein, but are not limited to such. The graphics processor core 219, sometimes referred to as a core slice, can be one or multiple graphics cores within a modular graphics processor. The graphics processor core 219 is exemplary of one graphics core slice, and a graphics processor as described herein may include multiple graphics core slices based on target power and performance envelopes. Each graphics processor core 219 can include a fixed function block 230 coupled with multiple sub-cores 221A-221F, also referred to as sub-slices, that include modular blocks of general-purpose and fixed function logic.

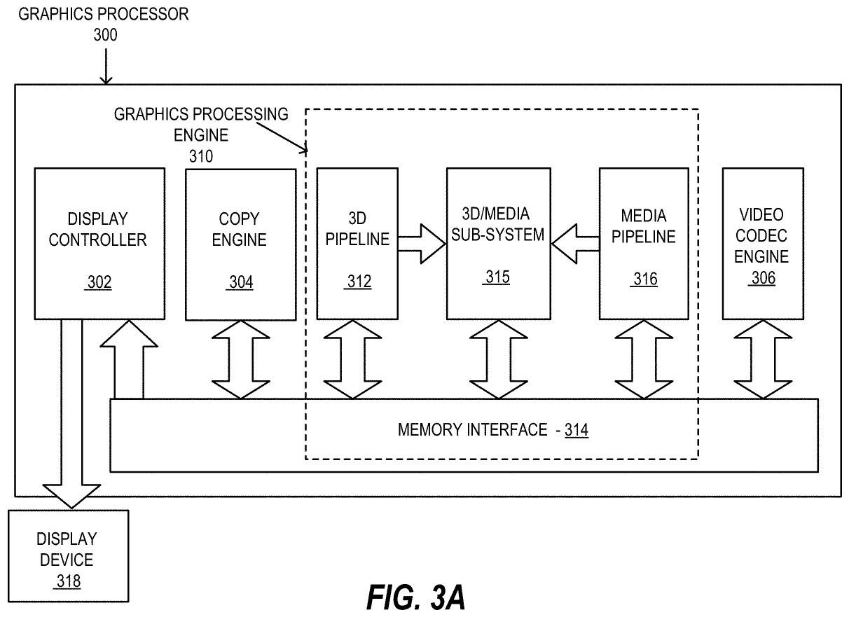

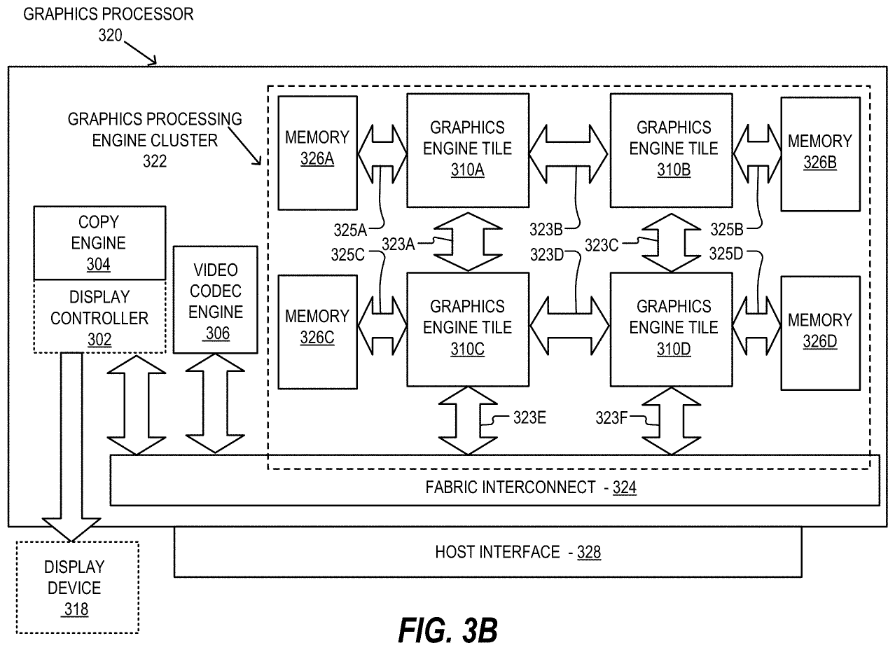

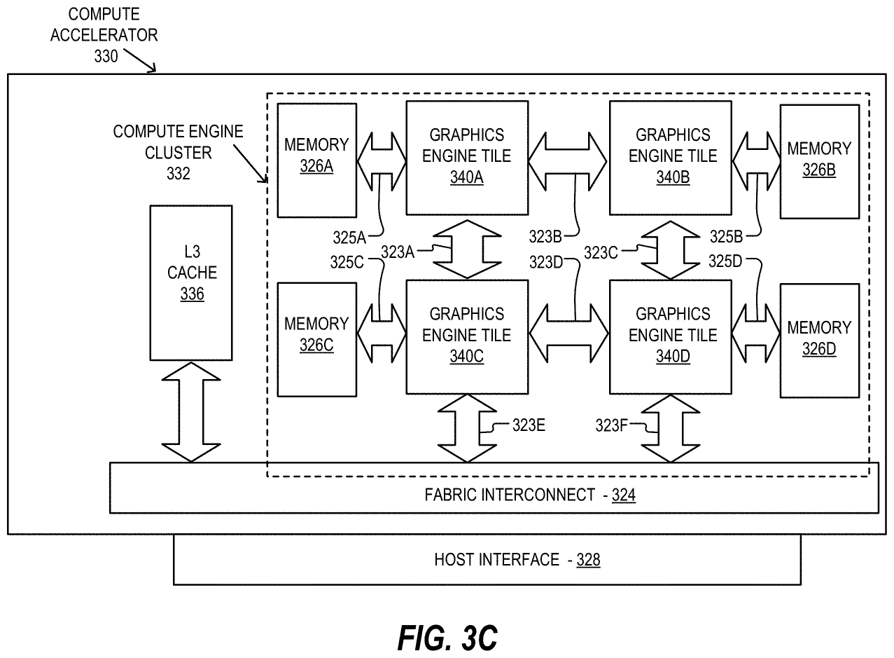

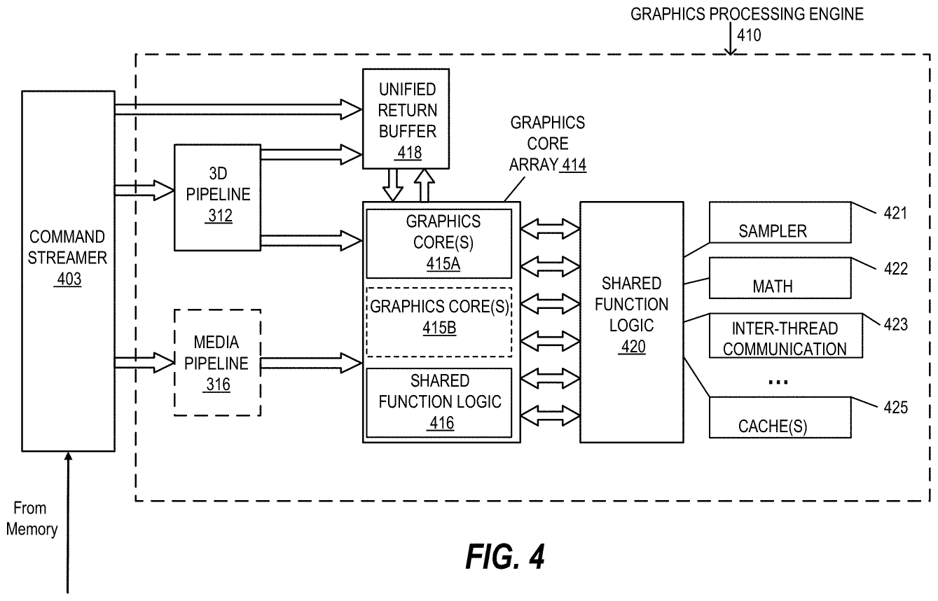

In some embodiments, the fixed function block 230 includes a geometry/fixed function pipeline 231 that can be shared by all sub-cores in the graphics processor core 219, for example, in lower performance and/or lower power graphics processor implementations. In various embodiments, the geometry/fixed function pipeline 231 includes a 3D fixed function pipeline (e.g., 3D pipeline 312 as in FIG. 3 and FIG. 4, described below) a video front-end unit, a thread spawner and thread dispatcher, and a unified return buffer manager, which manages unified return buffers (e.g., unified return buffer 418 in FIG. 4, as described below).

In one embodiment the fixed function block 230 also includes a graphics SoC interface 232, a graphics microcontroller 233, and a media pipeline 234. The graphics SoC interface 232 provides an interface between the graphics processor core 219 and other processor cores within a system on a chip integrated circuit. The graphics microcontroller 233 is a programmable sub-processor that is configurable to manage various functions of the graphics processor core 219, including thread dispatch, scheduling, and pre-emption. The media pipeline 234 (e.g., media pipeline 316 of FIG. 3 and FIG. 4) includes logic to facilitate the decoding, encoding, pre-processing, and/or post-processing of multimedia data, including image and video data. The media pipeline 234 implement media operations via requests to compute or sampling logic within the sub-cores 221-221F.

In one embodiment the SoC interface 232 enables the graphics processor core 219 to communicate with general-purpose application processor cores (e.g., CPUs) and/or other components within an SoC, including memory hierarchy elements such as a shared last level cache memory, the system RAM, and/or embedded on-chip or on-package DRAM. The SoC interface 232 can also enable communication with fixed function devices within the SoC, such as camera imaging pipelines, and enables the use of and/or implements global memory atomics that may be shared between the graphics processor core 219 and CPUs within the SoC. The SoC interface 232 can also implement power management controls for the graphics processor core 219 and enable an interface between a clock domain of the graphic core 219 and other clock domains within the SoC. In one embodiment the SoC interface 232 enables receipt of command buffers from a command streamer and global thread dispatcher that are configured to provide commands and instructions to each of one or more graphics cores within a graphics processor. The commands and instructions can be dispatched to the media pipeline 234, when media operations are to be performed, or a geometry and fixed function pipeline (e.g., geometry and fixed function pipeline 231, geometry and fixed function pipeline 237) when graphics processing operations are to be performed.

The graphics microcontroller 233 can be configured to perform various scheduling and management tasks for the graphics processor core 219. In one embodiment the graphics microcontroller 233 can perform graphics and/or compute workload scheduling on the various graphics parallel engines within execution unit (EU) arrays 222A-222F, 224A-224F within the sub-cores 221A-221F. In this scheduling model, host software executing on a CPU core of an SoC including the graphics processor core 219 can submit workloads one of multiple graphic processor doorbells, which invokes a scheduling operation on the appropriate graphics engine. Scheduling operations include determining which workload to run next, submitting a workload to a command streamer, pre-empting existing workloads running on an engine, monitoring progress of a workload, and notifying host software when a workload is complete. In one embodiment the graphics microcontroller 233 can also facilitate low-power or idle states for the graphics processor core 219, providing the graphics processor core 219 with the ability to save and restore registers within the graphics processor core 219 across low-power state transitions independently from the operating system and/or graphics driver software on the system.

The graphics processor core 219 may have greater than or fewer than the illustrated sub-cores 221A-221F, up to N modular sub-cores. For each set of N sub-cores, the graphics processor core 219 can also include shared function logic 235, shared and/or cache memory 236, a geometry/fixed function pipeline 237, as well as additional fixed function logic 238 to accelerate various graphics and compute processing operations. The shared function logic 235 can include logic units associated with the shared function logic 420 of FIG. 4 (e.g., sampler, math, and/or inter-thread communication logic) that can be shared by each N sub-cores within the graphics processor core 219. The shared and/or cache memory 236 can be a last-level cache for the set of N sub-cores 221A-221F within the graphics processor core 219, and can also serve as shared memory that is accessible by multiple sub-cores. The geometry/fixed function pipeline 237 can be included instead of the geometry/fixed function pipeline 231 within the fixed function block 230 and can include the same or similar logic units.

In one embodiment the graphics processor core 219 includes additional fixed function logic 238 that can include various fixed function acceleration logic for use by the graphics processor core 219. In one embodiment the additional fixed function logic 238 includes an additional geometry pipeline for use in position only shading. In position-only shading, two geometry pipelines exist, the full geometry pipeline within the geometry/fixed function pipeline 238, 231, and a cull pipeline, which is an additional geometry pipeline which may be included within the additional fixed function logic 238. In one embodiment the cull pipeline is a trimmed down version of the full geometry pipeline. The full pipeline and the cull pipeline can execute different instances of the same application, each instance having a separate context. Position only shading can hide long cull runs of discarded triangles, enabling shading to be completed earlier in some instances. For example and in one embodiment the cull pipeline logic within the additional fixed function logic 238 can execute position shaders in parallel with the main application and generally generates critical results faster than the full pipeline, as the cull pipeline fetches and shades only the position attribute of the vertices, without performing rasterization and rendering of the pixels to the frame buffer. The cull pipeline can use the generated critical results to compute visibility information for all the triangles without regard to whether those triangles are culled. The full pipeline (which in this instance may be referred to as a replay pipeline) can consume the visibility information to skip the culled triangles to shade only the visible triangles that are finally passed to the rasterization phase.

In one embodiment the additional fixed function logic 238 can also include machine-learning acceleration logic, such as fixed function matrix multiplication logic, for implementations including optimizations for machine learning training or inferencing.

Within each graphics sub-core 221A-221F includes a set of execution resources that may be used to perform graphics, media, and compute operations in response to requests by graphics pipeline, media pipeline, or shader programs. The graphics sub-cores 221A-221F include multiple EU arrays 222A-222F, 224A-224F, thread dispatch and inter-thread communication (TD/IC) logic 223A-223F, a 3D (e.g., texture) sampler 225A-225F, a media sampler 206A-206F, a shader processor 227A-227F, and shared local memory (SLM) 228A-228F. The EU arrays 222A-222F, 224A-224F each include multiple execution units, which are general-purpose graphics processing units capable of performing floating-point and integer/fixed-point logic operations in service of a graphics, media, or compute operation, including graphics, media, or compute shader programs. The TD/IC logic 223A-223F performs local thread dispatch and thread control operations for the execution units within a sub-core and facilitate communication between threads executing on the execution units of the sub-core. The 3D sampler 225A-225F can read texture or other 3D graphics related data into memory. The 3D sampler can read texture data differently based on a configured sample state and the texture format associated with a given texture. The media sampler 206A-206F can perform similar read operations based on the type and format associated with media data. In one embodiment, each graphics sub-core 221A-221F can alternately include a unified 3D and media sampler. Threads executing on the execution units within each of the sub-cores 221A-221F can make use of shared local memory 228A-228F within each sub-core, to enable threads executing within a thread group to execute using a common pool of on-chip memory.

FIG. 2C illustrates a graphics processing unit (GPU) 239 that includes dedicated sets of graphics processing resources arranged into multi-core groups 240A-240N. While the details of only a single multi-core group 240A are provided, it will be appreciated that the other multi-core groups 240B-240N may be equipped with the same or similar sets of graphics processing resources.

As illustrated, a multi-core group 240A may include a set of graphics cores 243, a set of tensor cores 244, and a set of ray tracing cores 245. A scheduler/dispatcher 241 schedules and dispatches the graphics threads for execution on the various cores 243, 244, 245. A set of register files 242 store operand values used by the cores 243, 244, 245 when executing the graphics threads. These may include, for example, integer registers for storing integer values, floating point registers for storing floating point values, vector registers for storing packed data elements (integer and/or floating point data elements) and tile registers for storing tensor/matrix values. In one embodiment, the tile registers are implemented as combined sets of vector registers.

One or more combined level 1 (L1) caches and shared memory units 247 store graphics data such as texture data, vertex data, pixel data, ray data, bounding volume data, etc., locally within each multi-core group 240A. One or more texture units 247 can also be used to perform texturing operations, such as texture mapping and sampling. A Level 2 (L2) cache 253 shared by all or a subset of the multi-core groups 240A-240N stores graphics data and/or instructions for multiple concurrent graphics threads. As illustrated, the L2 cache 253 may be shared across a plurality of multi-core groups 240A-240N. One or more memory controllers 248 couple the GPU 239 to a memory 249 which may be a system memory (e.g., DRAM) and/or a dedicated graphics memory (e.g., GDDR6 memory).

Input/output (I/O) circuitry 250 couples the GPU 239 to one or more I/O devices 252 such as digital signal processors (DSPs), network controllers, or user input devices. An on-chip interconnect may be used to couple the I/O devices 252 to the GPU 239 and memory 249. One or more I/O memory management units (IOMMUs) 251 of the I/O circuitry 250 couple the I/O devices 252 directly to the system memory 249. In one embodiment, the IOMMU 251 manages multiple sets of page tables to map virtual addresses to physical addresses in system memory 249. In this embodiment, the I/O devices 252, CPU(s) 246, and GPU(s) 239 may share the same virtual address space.

In one implementation, the IOMMU 251 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 249). The base addresses of each of the first and second sets of page tables may be stored in control registers and swapped out on a context switch (e.g., so that the new context is provided with access to the relevant set of page tables). While not illustrated in FIG. 2C, each of the cores 243, 244, 245 and/or multi-core groups 240A-240N may include translation lookaside buffers (TLBs) to cache guest virtual to guest physical translations, guest physical to host physical translations, and guest virtual to host physical translations.

In one embodiment, the CPUs 246, GPUs 239, and I/O devices 252 are integrated on a single semiconductor chip and/or chip package. The illustrated memory 249 may be integrated on the same chip or may be coupled to the memory controllers 248 via an off-chip interface. In one implementation, the memory 249 comprises GDDR6 memory which shares the same virtual address space as other physical system-level memories, although the underlying principles of the invention are not limited to this specific implementation.

In one embodiment, the tensor cores 244 include a plurality of execution units specifically designed to perform matrix operations, which are the fundamental compute operation used to perform deep learning operations. For example, simultaneous matrix multiplication operations may be used for neural network training and inferencing. The tensor cores 244 may perform matrix processing using a variety of operand precisions including single precision floating-point (e.g., 32 bits), half-precision floating point (e.g., 16 bits), integer words (16 bits), bytes (8 bits), and half-bytes (4 bits). In one embodiment, a neural network implementation extracts features of each rendered scene, potentially combining details from multiple frames, to construct a high-quality final image.

In deep learning implementations, parallel matrix multiplication work may be scheduled for execution on the tensor cores 244. The training of neural networks, in particular, requires a significant number of matrix dot product operations. In order to process an inner-product formulation of an N×N×N matrix multiply, the tensor cores 244 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 244 to ensure that the most efficient precision is used for different workloads (e.g., such as inferencing workloads which can tolerate quantization to bytes and half-bytes).

In one embodiment, the ray tracing cores 245 accelerate ray tracing operations for both real-time ray tracing and non-real-time ray tracing implementations. In particular, the ray tracing cores 245 include ray traversal/intersection circuitry for performing ray traversal using bounding volume hierarchies (BVHs) and identifying intersections between rays and primitives enclosed within the BVH volumes. The ray tracing cores 245 may also include circuitry for performing depth testing and culling (e.g., using a Z buffer or similar arrangement). In one implementation, the ray tracing cores 245 perform traversal and intersection operations in concert with the image denoising techniques described herein, at least a portion of which may be executed on the tensor cores 244. For example, in one embodiment, the tensor cores 244 implement a deep learning neural network to perform denoising of frames generated by the ray tracing cores 245. However, the CPU(s) 246, graphics cores 243, and/or ray tracing cores 245 may also implement all or a portion of the denoising and/or deep learning algorithms.

In addition, as described above, a distributed approach to denoising may be employed in which the GPU 239 is in a computing device coupled to other computing devices over a network or high speed interconnect. In this embodiment, the interconnected computing devices share neural network learning/training data to improve the speed with which the overall system learns to perform denoising for different types of image frames and/or different graphics applications.

In one embodiment, the ray tracing cores 245 process all BVH traversal and ray-primitive intersections, saving the graphics cores 243 from being overloaded with thousands of instructions per ray. In one embodiment, each ray tracing core 245 includes a first set of specialized circuitries for performing bounding box tests (e.g., for traversal operations) and a second set of specialized circuitry for performing the ray-triangle intersection tests (e.g., intersecting rays which have been traversed). Thus, in one embodiment, the multi-core group 240A can simply launch a ray probe, and the ray tracing cores 245 independently perform ray traversal and intersection and return hit data (e.g., a hit, no hit, multiple hits, etc.) to the thread context. The other cores 243, 244 are freed to perform other graphics or compute work while the ray tracing cores 245 perform the traversal and intersection operations.

In one embodiment, each ray tracing core 245 includes a traversal unit to perform BVH testing operations and an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 243 and tensor cores 244) are freed to perform other forms of graphics work.

In one particular embodiment described below, a hybrid rasterization/ray tracing approach is used in which work is distributed between the graphics cores 243 and ray tracing cores 245.

In one embodiment, the ray tracing cores 245 (and/or other cores 243, 244) include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 245, graphics cores 243 and tensor cores 244 is Vulkan 1.1.85. Note, however, that the underlying principles of the invention are not limited to any particular ray tracing ISA.

In general, the various cores 245, 244, 243 may support a ray tracing instruction set that includes instructions/functions for ray generation, closest hit, any hit, ray-primitive intersection, per-primitive and hierarchical bounding box construction, miss, visit, and exceptions. More specifically, one embodiment includes ray tracing instructions to perform the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the children volumes a ray will traverse.
Exceptions—Includes various types of exception handlers (e.g., invoked for various error conditions).

FIG. 2D is a block diagram of general purpose graphics processing unit (GPGPU) 270 that can be configured as a graphics processor and/or compute accelerator, according to embodiments described herein. The GPGPU 270 can interconnect with host processors (e.g., one or more CPU(s) 246) and memory 271, 272 via one or more system and/or memory busses. In one embodiment the memory 271 is system memory that may be shared with the one or more CPU(s) 246, while memory 272 is device memory that is dedicated to the GPGPU 270. In one embodiment, components within the GPGPU 270 and device memory 272 may be mapped into memory addresses that are accessible to the one or more CPU(s) 246. Access to memory 271 and 272 may be facilitated via a memory controller 268. In one embodiment the memory controller 268 includes an internal direct memory access (DMA) controller 269 or can include logic to perform operations that would otherwise be performed by a DMA controller.

The GPGPU 270 includes multiple cache memories, including an L2 cache 253, L1 cache 254, an instruction cache 255, and shared memory 256, at least a portion of which may also be partitioned as a cache memory. The GPGPU 270 also includes multiple compute units 260A-260N. Each compute unit 260A-260N includes a set of vector registers 261, scalar registers 262, vector logic units 263, and scalar logic units 264. The compute units 260A-260N can also include local shared memory 265 and a program counter 266. The compute units 260A-260N can couple with a constant cache 267, which can be used to store constant data, which is data that will not change during the run of kernel or shader program that executes on the GPGPU 270. In one embodiment the constant cache 267 is a scalar data cache and cached data can be fetched directly into the scalar registers 262.

During operation, the one or more CPU(s) 246 can write commands into registers or memory in the GPGPU 270 that has been mapped into an accessible address space. The command processors 257 can read the commands from registers or memory and determine how those commands will be processed within the GPGPU 270. A thread dispatcher 258 can then be used to dispatch threads to the compute units 260A-260N to perform those commands. Each compute unit 260A-260N can execute threads independently of the other compute units. Additionally, each compute unit 260A-260N can be independently configured for conditional computation and can conditionally output the results of computation to memory. The command processors 257 can interrupt the one or more CPU(s) 246 when the submitted commands are complete.

FIGS. 3A-3C illustrate block diagrams of additional graphics processor and compute accelerator architectures provided by embodiments described herein. The elements of FIGS. 3A-3C having the same reference numbers (or names) as the elements of any other figure herein can operate or function in any manner similar to that described elsewhere herein, but are not limited to such.

FIG. 3A is a block diagram of a graphics processor 300, which may be a discrete graphics processing unit, or may be a graphics processor integrated with a plurality of processing cores, or other semiconductor devices such as, but not limited to, memory devices or network interfaces. In some embodiments, the graphics processor communicates via a memory mapped I/O interface to registers on the graphics processor and with commands placed into the processor memory. In some embodiments, graphics processor 300 includes a memory interface 314 to access memory. Memory interface 314 can be an interface to local memory, one or more internal caches, one or more shared external caches, and/or to system memory.

In some embodiments, graphics processor 300 also includes a display controller 302 to drive display output data to a display device 318. Display controller 302 includes hardware for one or more overlay planes for the display and composition of multiple layers of video or user interface elements. The display device 318 can be an internal or external display device. In one embodiment the display device 318 is a head mounted display device, such as a virtual reality (VR) display device or an augmented reality (AR) display device. In some embodiments, graphics processor 300 includes a video codec engine 306 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, H.265/HEVC, Alliance for Open Media (AOMedia) VP8, VP9, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 300 includes a block image transfer (BLIT) engine 304 to perform two-dimensional (2D) rasterizer operations including, for example, bit-boundary block transfers. However, in one embodiment, 2D graphics operations are performed using one or more components of graphics processing engine (GPE) 310. In some embodiments, GPE 310 is a compute engine for performing graphics operations, including three-dimensional (3D) graphics operations and media operations.

In some embodiments, GPE 310 includes a 3D pipeline 312 for performing 3D operations, such as rendering three-dimensional images and scenes using processing functions that act upon 3D primitive shapes (e.g., rectangle, triangle, etc.). The 3D pipeline 312 includes programmable and fixed function elements that perform various tasks within the element and/or spawn execution threads to a 3D/Media sub-system 315. While 3D pipeline 312 can be used to perform media operations, an embodiment of GPE 310 also includes a media pipeline 316 that is specifically used to perform media operations, such as video post-processing and image enhancement.

In some embodiments, media pipeline 316 includes fixed function or programmable logic units to perform one or more specialized media operations, such as video decode acceleration, video de-interlacing, and video encode acceleration in place of, or on behalf of video codec engine 306. In some embodiments, media pipeline 316 additionally includes a thread spawning unit to spawn threads for execution on 3D/Media sub-system 315. The spawned threads perform computations for the media operations on one or more graphics execution units included in 3D/Media sub-system 315.

In some embodiments, 3D/Media subsystem 315 includes logic for executing threads spawned by 3D pipeline 312 and media pipeline 316. In one embodiment, the pipelines send thread execution requests to 3D/Media subsystem 315, which includes thread dispatch logic for arbitrating and dispatching the various requests to available thread execution resources. The execution resources include an array of graphics execution units to process the 3D and media threads. In some embodiments, 3D/Media subsystem 315 includes one or more internal caches for thread instructions and data. In some embodiments, the subsystem also includes shared memory, including registers and addressable memory, to share data between threads and to store output data.

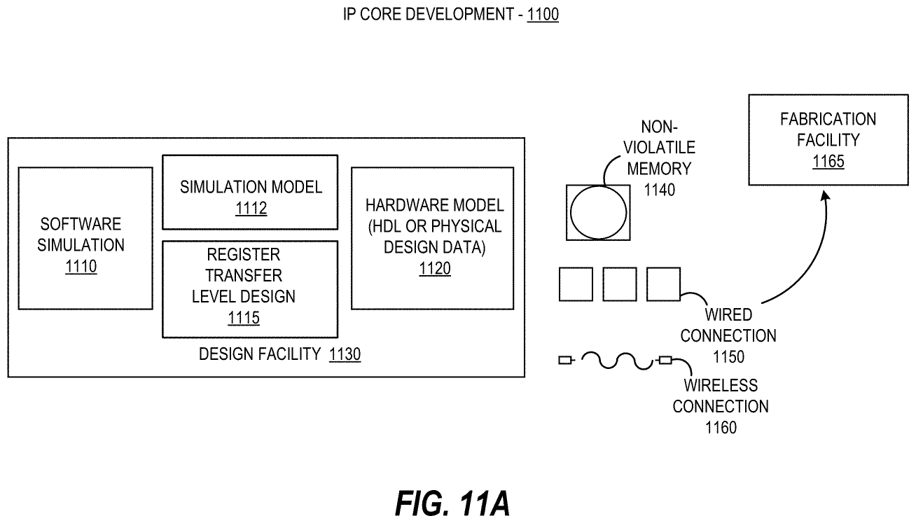

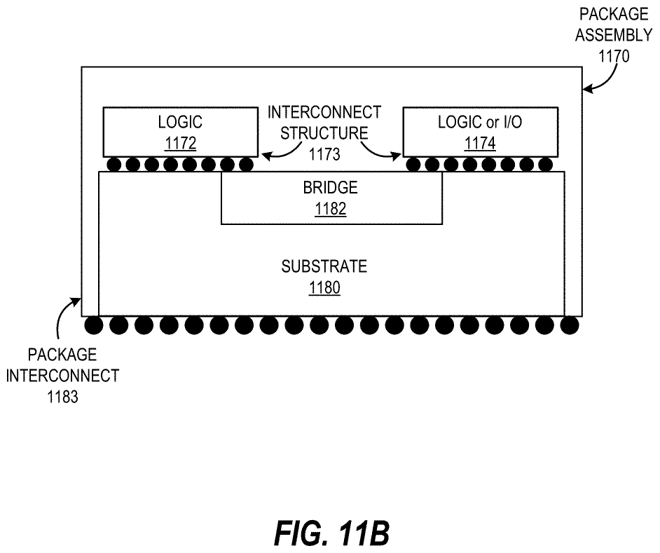

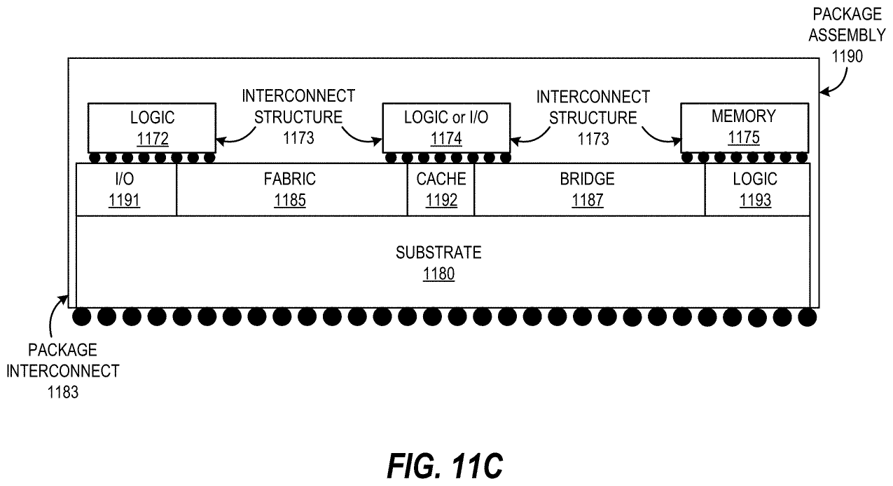

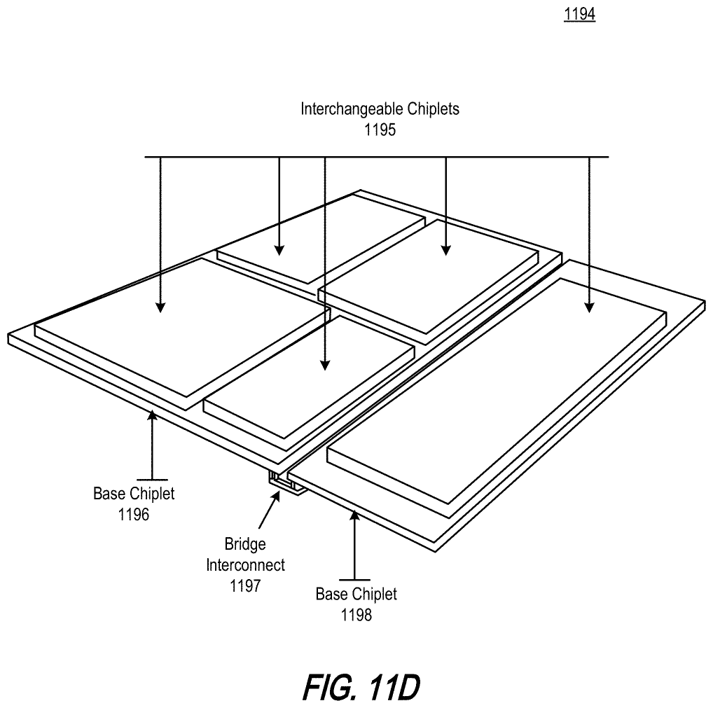

FIG. 3B illustrates a graphics processor 320 having a tiled architecture, according to embodiments described herein. In one embodiment the graphics processor 320 includes a graphics processing engine cluster 322 having multiple instances of the graphics processing engine 310 of FIG. 3A within a graphics engine tile 310A-310D. Each graphics engine tile 310A-310D can be interconnected via a set of tile interconnects 323A-323F. Each graphics engine tile 310A-310D can also be connected to a memory module or memory device 326A-326D via memory interconnects 325A-325D. The memory devices 326A-326D can use any graphics memory technology. For example, the memory devices 326A-326D may be graphics double data rate (GDDR) memory. The memory devices 326A-326D, in one embodiment, are high-bandwidth memory (HBM) modules that can be on-die with their respective graphics engine tile 310A-310D. In one embodiment the memory devices 326A-326D are stacked memory devices that can be stacked on top of their respective graphics engine tile 310A-310D. In one embodiment, each graphics engine tile 310A-310D and associated memory 326A-326D reside on separate chiplets, which are bonded to a base die or base substrate, as described on further detail in FIGS. 11B-11D.

The graphics processing engine cluster 322 can connect with an on-chip or on-package fabric interconnect 324. The fabric interconnect 324 can enable communication between graphics engine tiles 310A-310D and components such as the video codec 306 and one or more copy engines 304. The copy engines 304 can be used to move data out of, into, and between the memory devices 326A-326D and memory that is external to the graphics processor 320 (e.g., system memory). The fabric interconnect 324 can also be used to interconnect the graphics engine tiles 310A-310D. The graphics processor 320 may optionally include a display controller 302 to enable a connection with an external display device 318. The graphics processor may also be configured as a graphics or compute accelerator. In the accelerator configuration, the display controller 302 and display device 318 may be omitted.

The graphics processor 320 can connect to a host system via a host interface 328. The host interface 328 can enable communication between the graphics processor 320, system memory, and/or other system components. The host interface 328 can be, for example a PCI express bus or another type of host system interface.

FIG. 3C illustrates a compute accelerator 330, according to embodiments described herein. The compute accelerator 330 can include architectural similarities with the graphics processor 320 of FIG. 3B and is optimized for compute acceleration. A compute engine cluster 332 can include a set of compute engine tiles 340A-340D that include execution logic that is optimized for parallel or vector-based general-purpose compute operations. In some embodiments, the compute engine tiles 340A-340D do not include fixed function graphics processing logic, although in one embodiment one or more of the compute engine tiles 340A-340D can include logic to perform media acceleration. The compute engine tiles 340A-340D can connect to memory 326A-326D via memory interconnects 325A-325D. The memory 326A-326D and memory interconnects 325A-325D may be similar technology as in graphics processor 320, or can be different. The graphics compute engine tiles 340A-340D can also be interconnected via a set of tile interconnects 323A-323F and may be connected with and/or interconnected by a fabric interconnect 324. In one embodiment the compute accelerator 330 includes a large L3 cache 336 that can be configured as a device-wide cache. The compute accelerator 330 can also connect to a host processor and memory via a host interface 328 in a similar manner as the graphics processor 320 of FIG. 3B.

### Graphics Processing Engine

FIG. 4 is a block diagram of a graphics processing engine 410 of a graphics processor in accordance with some embodiments. In one embodiment, the graphics processing engine (GPE) 410 is a version of the GPE 310 shown in FIG. 3A, and may also represent a graphics engine tile 310A-310D of FIG. 3B. Elements of FIG. 4 having the same reference numbers (or names) as the elements of any other figure herein can operate or function in any manner similar to that described elsewhere herein, but are not limited to such. For example, the 3D pipeline 312 and media pipeline 316 of FIG. 3A are illustrated. The media pipeline 316 is optional in some embodiments of the GPE 410 and may not be explicitly included within the GPE 410. For example, and in at least one embodiment, a separate media and/or image processor is coupled to the GPE 410.

In some embodiments, GPE 410 couples with or includes a command streamer 403, which provides a command stream to the 3D pipeline 312 and/or media pipelines 316. In some embodiments, command streamer 403 is coupled with memory, which can be system memory, or one or more of internal cache memory and shared cache memory. In some embodiments, command streamer 403 receives commands from the memory and sends the commands to 3D pipeline 312 and/or media pipeline 316. The commands are directives fetched from a ring buffer, which stores commands for the 3D pipeline 312 and media pipeline 316. In one embodiment, the ring buffer can additionally include batch command buffers storing batches of multiple commands. The commands for the 3D pipeline 312 can also include references to data stored in memory, such as but not limited to vertex and geometry data for the 3D pipeline 312 and/or image data and memory objects for the media pipeline 316. The 3D pipeline 312 and media pipeline 316 process the commands and data by performing operations via logic within the respective pipelines or by dispatching one or more execution threads to a graphics core array 414. In one embodiment the graphics core array 414 include one or more blocks of graphics cores (e.g., graphics core(s) 415A, graphics core(s) 415B), each block including one or more graphics cores. Each graphics core includes a set of graphics execution resources that includes general-purpose and graphics specific execution logic to perform graphics and compute operations, as well as fixed function texture processing and/or machine learning and artificial intelligence acceleration logic.

In various embodiments the 3D pipeline 312 can include fixed function and programmable logic to process one or more shader programs, such as vertex shaders, geometry shaders, pixel shaders, fragment shaders, compute shaders, or other shader programs, by processing the instructions and dispatching execution threads to the graphics core array 414. The graphics core array 414 provides a unified block of execution resources for use in processing these shader programs. Multi-purpose execution logic (e.g., execution units) within the graphics core(s) 415A-414B of the graphic core array 414 includes support for various 3D API shader languages and can execute multiple simultaneous execution threads associated with multiple shaders.

In some embodiments, the graphics core array 414 includes execution logic to perform media functions, such as video and/or image processing. In one embodiment, the execution units include general-purpose logic that is programmable to perform parallel general-purpose computational operations, in addition to graphics processing operations. The general-purpose logic can perform processing operations in parallel or in conjunction with general-purpose logic within the processor core(s) 107 of FIG. 1 or core 202A-202N as in FIG. 2A.

Output data generated by threads executing on the graphics core array 414 can output data to memory in a unified return buffer (URB) 418. The URB 418 can store data for multiple threads. In some embodiments the URB 418 may be used to send data between different threads executing on the graphics core array 414. In some embodiments the URB 418 may additionally be used for synchronization between threads on the graphics core array and fixed function logic within the shared function logic 420.

In some embodiments, graphics core array 414 is scalable, such that the array includes a variable number of graphics cores, each having a variable number of execution units based on the target power and performance level of GPE 410. In one embodiment the execution resources are dynamically scalable, such that execution resources may be enabled or disabled as needed.

The graphics core array 414 couples with shared function logic 420 that includes multiple resources that are shared between the graphics cores in the graphics core array. The shared functions within the shared function logic 420 are hardware logic units that provide specialized supplemental functionality to the graphics core array 414. In various embodiments, shared function logic 420 includes but is not limited to sampler 421, math 422, and inter-thread communication (ITC) 423 logic. Additionally, some embodiments implement one or more cache(s) 425 within the shared function logic 420.

A shared function is implemented at least in a case where the demand for a given specialized function is insufficient for inclusion within the graphics core array 414. Instead a single instantiation of that specialized function is implemented as a stand-alone entity in the shared function logic 420 and shared among the execution resources within the graphics core array 414. The precise set of functions that are shared between the graphics core array 414 and included within the graphics core array 414 varies across embodiments. In some embodiments, specific shared functions within the shared function logic 420 that are used extensively by the graphics core array 414 may be included within shared function logic 416 within the graphics core array 414. In various embodiments, the shared function logic 416 within the graphics core array 414 can include some or all logic within the shared function logic 420. In one embodiment, all logic elements within the shared function logic 420 may be duplicated within the shared function logic 416 of the graphics core array 414. In one embodiment the shared function logic 420 is excluded in favor of the shared function logic 416 within the graphics core array 414.

### Execution Units

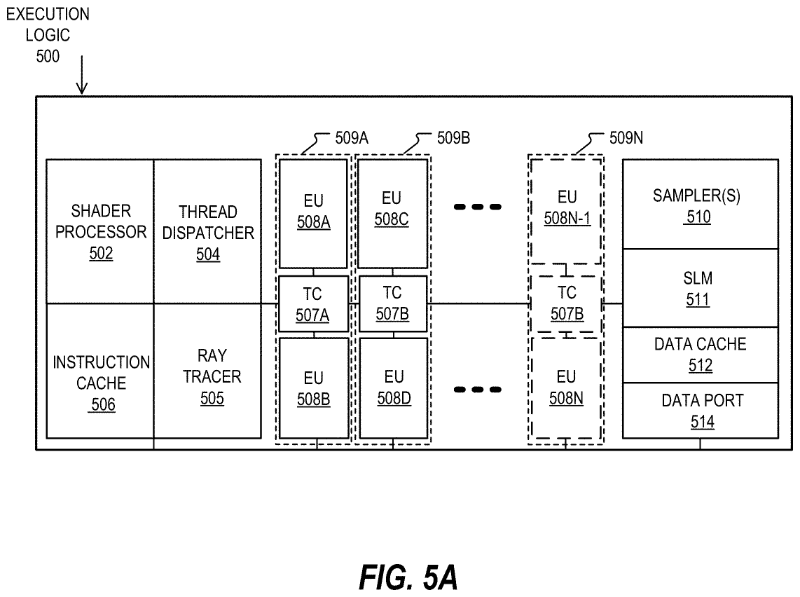

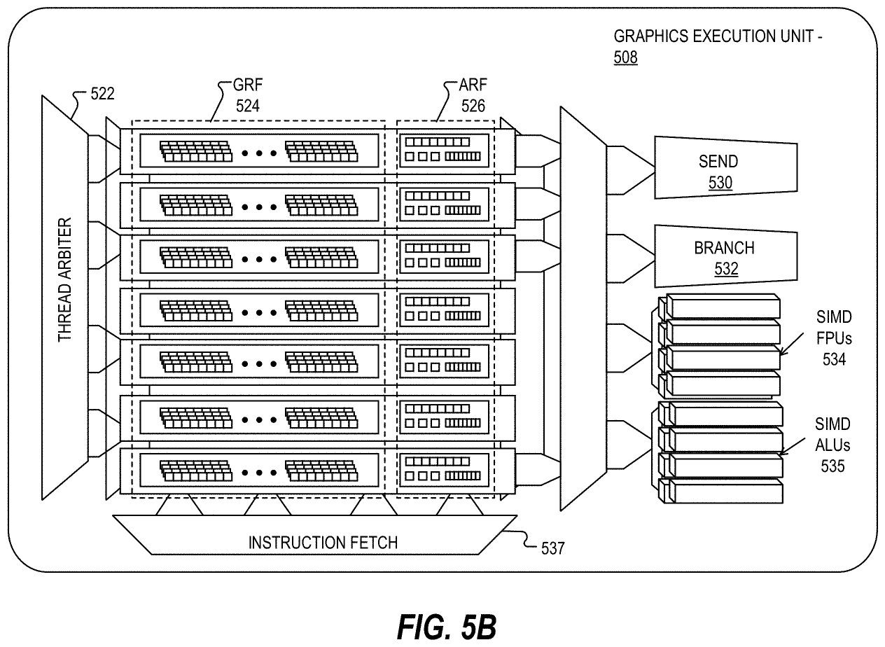

FIGS. 5A-5B illustrate thread execution logic 500 including an array of processing elements employed in a graphics processor core according to embodiments described herein. Elements of FIGS. 5A-5B having the same reference numbers (or names) as the elements of any other figure herein can operate or function in any manner similar to that described elsewhere herein, but are not limited to such. FIG. 5A-5B illustrates an overview of thread execution logic 500, which may be representative of hardware logic illustrated with each sub-core 221A-221F of FIG. 2B. FIG. 5A is representative of an execution unit within a general-purpose graphics processor, while FIG. 5B is representative of an execution unit that may be used within a compute accelerator.

As illustrated in FIG. 5A, in some embodiments thread execution logic 500 includes a shader processor 502, a thread dispatcher 504, instruction cache 506, a scalable execution unit array including a plurality of execution units 508A-508N, a sampler 510, shared local memory 511, a data cache 512, and a data port 514. In one embodiment the scalable execution unit array can dynamically scale by enabling or disabling one or more execution units (e.g., any of execution units 508A, 508B, 508C, 508D, through 508N−1 and 508N) based on the computational requirements of a workload. In one embodiment the included components are interconnected via an interconnect fabric that links to each of the components. In some embodiments, thread execution logic 500 includes one or more connections to memory, such as system memory or cache memory, through one or more of instruction cache 506, data port 514, sampler 510, and execution units 508A-508N. In some embodiments, each execution unit (e.g. 508A) is a stand-alone programmable general-purpose computational unit that is capable of executing multiple simultaneous hardware threads while processing multiple data elements in parallel for each thread. In various embodiments, the array of execution units 508A-508N is scalable to include any number individual execution units.

In some embodiments, the execution units 508A-508N are primarily used to execute shader programs. A shader processor 502 can process the various shader programs and dispatch execution threads associated with the shader programs via a thread dispatcher 504. In one embodiment the thread dispatcher includes logic to arbitrate thread initiation requests from the graphics and media pipelines and instantiate the requested threads on one or more execution unit in the execution units 508A-508N. For example, a geometry pipeline can dispatch vertex, tessellation, or geometry shaders to the thread execution logic for processing. In some embodiments, thread dispatcher 504 can also process runtime thread spawning requests from the executing shader programs.

In some embodiments, the execution units 508A-508N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 508A-508N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 508A-508N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various embodiments can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 508A-508N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some embodiments, execution units 508A-508N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 54-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In one embodiment one or more execution units can be combined into a fused execution unit 509A-509N having thread control logic (507A-507N) that is common to the fused EUs. Multiple EUs can be fused into an EU group. Each EU in the fused EU group can be configured to execute a separate SIMD hardware thread. The number of EUs in a fused EU group can vary according to embodiments. Additionally, various SIMD widths can be performed per-EU, including but not limited to SIMD8, SIMD16, and SIMD32. Each fused graphics execution unit 509A-509N includes at least two execution units. For example, fused execution unit 509A includes a first EU 508A, second EU 508B, and thread control logic 507A that is common to the first EU 508A and the second EU 508B. The thread control logic 507A controls threads executed on the fused graphics execution unit 509A, allowing each EU within the fused execution units 509A-509N to execute using a common instruction pointer register.

One or more internal instruction caches (e.g., 506) are included in the thread execution logic 500 to cache thread instructions for the execution units. In some embodiments, one or more data caches (e.g., 512) are included to cache thread data during thread execution. Threads executing on the execution logic 500 can also store explicitly managed data in the shared local memory 511. In some embodiments, a sampler 510 is included to provide texture sampling for 3D operations and media sampling for media operations. In some embodiments, sampler 510 includes specialized texture or media sampling functionality to process texture or media data during the sampling process before providing the sampled data to an execution unit.

During execution, the graphics and media pipelines send thread initiation requests to thread execution logic 500 via thread spawning and dispatch logic. Once a group of geometric objects has been processed and rasterized into pixel data, pixel processor logic (e.g., pixel shader logic, fragment shader logic, etc.) within the shader processor 502 is invoked to further compute output information and cause results to be written to output surfaces (e.g., color buffers, depth buffers, stencil buffers, etc.). In some embodiments, a pixel shader or fragment shader calculates the values of the various vertex attributes that are to be interpolated across the rasterized object. In some embodiments, pixel processor logic within the shader processor 502 then executes an application programming interface (API)-supplied pixel or fragment shader program. To execute the shader program, the shader processor 502 dispatches threads to an execution unit (e.g., 508A) via thread dispatcher 504. In some embodiments, shader processor 502 uses texture sampling logic in the sampler 510 to access texture data in texture maps stored in memory. Arithmetic operations on the texture data and the input geometry data compute pixel color data for each geometric fragment, or discards one or more pixels from further processing.

In some embodiments, the data port 514 provides a memory access mechanism for the thread execution logic 500 to output processed data to memory for further processing on a graphics processor output pipeline. In some embodiments, the data port 514 includes or couples to one or more cache memories (e.g., data cache 512) to cache data for memory access via the data port.

In one embodiment, the execution logic 500 can also include a ray tracer 505 that can provide ray tracing acceleration functionality. The ray tracer 505 can support a ray tracing instruction set that includes instructions/functions for ray generation. The ray tracing instruction set can be similar to or different from the ray-tracing instruction set supported by the ray tracing cores 245 in FIG. 2C.

FIG. 5B illustrates exemplary internal details of an execution unit 508, according to embodiments. A graphics execution unit 508 can include an instruction fetch unit 537, a general register file array (GRF) 524, an architectural register file array (ARF) 526, a thread arbiter 522, a send unit 530, a branch unit 532, a set of SIMD floating point units (FPUs) 534, and in one embodiment a set of dedicated integer SIMD ALUs 535. The GRF 524 and ARF 526 includes the set of general register files and architecture register files associated with each simultaneous hardware thread that may be active in the graphics execution unit 508. In one embodiment, per thread architectural state is maintained in the ARF 526, while data used during thread execution is stored in the GRF 524. The execution state of each thread, including the instruction pointers for each thread, can be held in thread-specific registers in the ARF 526.

In one embodiment the graphics execution unit 508 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 508 is not limited to the number of hardware threads, and multiple logical threads can be assigned to each hardware thread.

In one embodiment, the graphics execution unit 508 can co-issue multiple instructions, which may each be different instructions. The thread arbiter 522 of the graphics execution unit thread 508 can dispatch the instructions to one of the send unit 530, branch unit 532, or SIMD FPU(s) 534 for execution. Each execution thread can access 128 general-purpose registers within the GRF 524, where each register can store 32 bytes, accessible as a SIMD 8-element vector of 32-bit data elements. In one embodiment, each execution unit thread has access to 4 Kbytes within the GRF 524, although embodiments are not so limited, and greater or fewer register resources may be provided in other embodiments. In one embodiment the graphics execution unit 508 is partitioned into seven hardware threads that can independently perform computational operations, although the number of threads per execution unit can also vary according to embodiments. For example, in one embodiment up to 16 hardware threads are supported. In an embodiment in which seven threads may access 4 Kbytes, the GRF 524 can store a total of 28 Kbytes. Where 16 threads may access 4 Kbytes, the GRF 524 can store a total of 64 Kbytes. Flexible addressing modes can permit registers to be addressed together to build effectively wider registers or to represent strided rectangular block data structures.

In one embodiment, memory operations, sampler operations, and other longer-latency system communications are dispatched via “send” instructions that are executed by the message passing send unit 530. In one embodiment, branch instructions are dispatched to a dedicated branch unit 532 to facilitate SIMD divergence and eventual convergence.

In one embodiment the graphics execution unit 508 includes one or more SIMD floating point units (FPU(s)) 534 to perform floating-point operations. In one embodiment, the FPU(s) 534 also support integer computation. In one embodiment the FPU(s) 534 can SIMD execute up to M number of 32-bit floating-point (or integer) operations, or SIMD execute up to 2M 16-bit integer or 16-bit floating-point operations. In one embodiment, at least one of the FPU(s) provides extended math capability to support high-throughput transcendental math functions and double precision 54-bit floating-point. In some embodiments, a set of 8-bit integer SIMD ALUs 535 are also present, and may be specifically optimized to perform operations associated with machine learning computations.

In one embodiment, arrays of multiple instances of the graphics execution unit 508 can be instantiated in a graphics sub-core grouping (e.g., a sub-slice). For scalability, product architects can choose the exact number of execution units per sub-core grouping. In one embodiment the execution unit 508 can execute instructions across a plurality of execution channels. In a further embodiment, each thread executed on the graphics execution unit 508 is executed on a different channel.

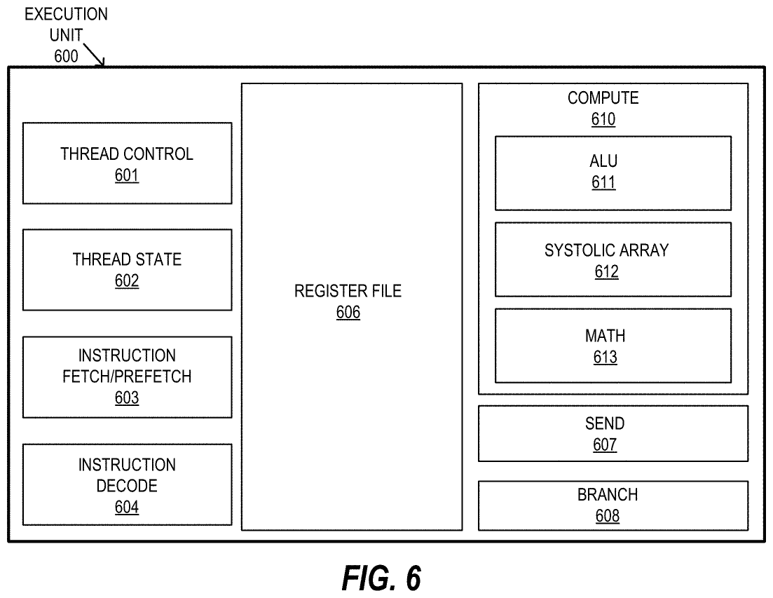

FIG. 6 illustrates an additional execution unit 600, according to an embodiment. The execution unit 600 may be a compute-optimized execution unit for use in, for example, a compute engine tile 340A-340D as in FIG. 3C, but is not limited as such. Variants of the execution unit 600 may also be used in a graphics engine tile 310A-310D as in FIG. 3B. In one embodiment, the execution unit 600 includes a thread control unit 601, a thread state unit 602, an instruction fetch/prefetch unit 603, and an instruction decode unit 604. The execution unit 600 additionally includes a register file 606 that stores registers that can be assigned to hardware threads within the execution unit. The execution unit 600 additionally includes a send unit 607 and a branch unit 608. In one embodiment, the send unit 607 and branch unit 608 can operate similarly as the send unit 530 and a branch unit 532 of the graphics execution unit 508 of FIG. 5B.

The execution unit 600 also includes a compute unit 610 that includes multiple different types of functional units. In one embodiment the compute unit 610 includes an ALU unit 611 that includes an array of arithmetic logic units. The ALU unit 611 can be configured to perform 64-bit, 32-bit, and 16-bit integer and floating point operations. Integer and floating point operations may be performed simultaneously. The compute unit 610 can also include a systolic array 612, and a math unit 613. The systolic array 612 includes a W wide and D deep network of data processing units that can be used to perform vector or other data-parallel operations in a systolic manner. In one embodiment the systolic array 612 can be configured to perform matrix operations, such as matrix dot product operations. In one embodiment the systolic array 612 support 16-bit floating point operations, as well as 8-bit and 4-bit integer operations. In one embodiment the systolic array 612 can be configured to accelerate machine learning operations. In such embodiments, the systolic array 612 can be configured with support for the bfloat 16-bit floating point format. In one embodiment, a math unit 613 can be included to perform a specific subset of mathematical operations in an efficient and lower-power manner than then ALU unit 611. The math unit 613 can include a variant of math logic that may be found in shared function logic of a graphics processing engine provided by other embodiments (e.g., math logic 422 of the shared function logic 420 of FIG. 4). In one embodiment the math unit 613 can be configured to perform 32-bit and 64-bit floating point operations.

The thread control unit 601 includes logic to control the execution of threads within the execution unit. The thread control unit 601 can include thread arbitration logic to start, stop, and preempt execution of threads within the execution unit 600. The thread state unit 602 can be used to store thread state for threads assigned to execute on the execution unit 600. Storing the thread state within the execution unit 600 enables the rapid pre-emption of threads when those threads become blocked or idle. The instruction fetch/prefetch unit 603 can fetch instructions from an instruction cache of higher level execution logic (e.g., instruction cache 506 as in FIG. 5A). The instruction fetch/prefetch unit 603 can also issue prefetch requests for instructions to be loaded into the instruction cache based on an analysis of currently executing threads. The instruction decode unit 604 can be used to decode instructions to be executed by the compute units. In one embodiment, the instruction decode unit 604 can be used as a secondary decoder to decode complex instructions into constituent micro-operations.

The execution unit 600 additionally includes a register file 606 that can be used by hardware threads executing on the execution unit 600. Registers in the register file 606 can be divided across the logic used to execute multiple simultaneous threads within the compute unit 610 of the execution unit 600. The number of logical threads that may be executed by the graphics execution unit 600 is not limited to the number of hardware threads, and multiple logical threads can be assigned to each hardware thread. The size of the register file 606 can vary across embodiments based on the number of supported hardware threads. In one embodiment, register renaming may be used to dynamically allocate registers to hardware threads.

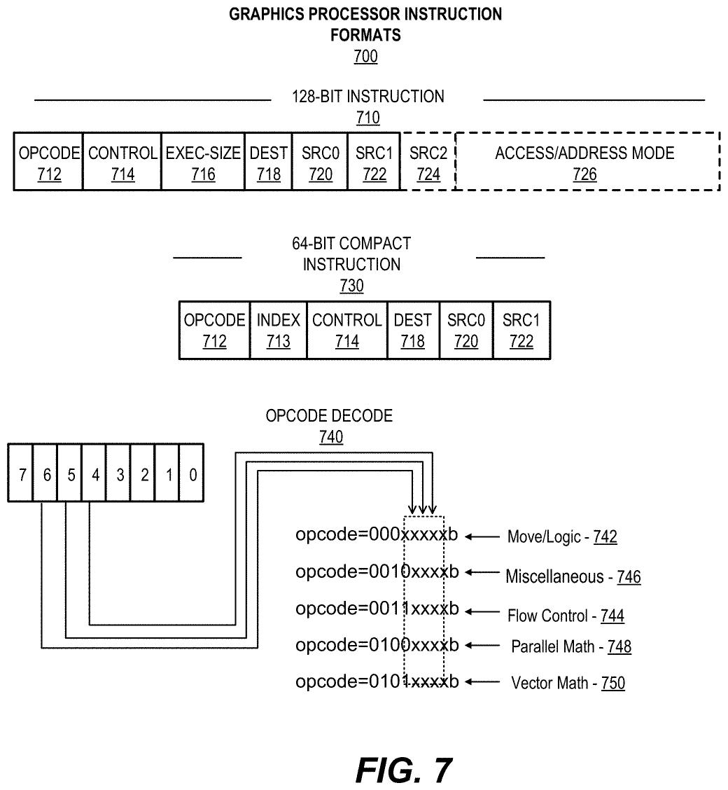

FIG. 7 is a block diagram illustrating a graphics processor instruction formats 700 according to some embodiments. In one or more embodiment, the graphics processor execution units support an instruction set having instructions in multiple formats. The solid lined boxes illustrate the components that are generally included in an execution unit instruction, while the dashed lines include components that are optional or that are only included in a sub-set of the instructions. In some embodiments, instruction format 700 described and illustrated are macro-instructions, in that they are instructions supplied to the execution unit, as opposed to micro-operations resulting from instruction decode once the instruction is processed.

In some embodiments, the graphics processor execution units natively support instructions in a 128-bit instruction format 710. A 64-bit compacted instruction format 730 is available for some instructions based on the selected instruction, instruction options, and number of operands. The native 128-bit instruction format 710 provides access to all instruction options, while some options and operations are restricted in the 64-bit format 730. The native instructions available in the 64-bit format 730 vary by embodiment. In some embodiments, the instruction is compacted in part using a set of index values in an index field 713. The execution unit hardware references a set of compaction tables based on the index values and uses the compaction table outputs to reconstruct a native instruction in the 128-bit instruction format 710. Other sizes and formats of instruction can be used.

For each format, instruction opcode 712 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some embodiments, instruction control field 714 enables control over certain execution options, such as channels selection (e.g., predication) and data channel order (e.g., swizzle). For instructions in the 128-bit instruction format 710 an exec-size field 716 limits the number of data channels that will be executed in parallel. In some embodiments, exec-size field 716 is not available for use in the 64-bit compact instruction format 730.

Some execution unit instructions have up to three operands including two source operands, src0 720, src1 722, and one destination 718. In some embodiments, the execution units support dual destination instructions, where one of the destinations is implied. Data manipulation instructions can have a third source operand (e.g., SRC2 724), where the instruction opcode 712 determines the number of source operands. An instruction's last source operand can be an immediate (e.g., hard-coded) value passed with the instruction.

In some embodiments, the 128-bit instruction format 710 includes an access/address mode field 726 specifying, for example, whether direct register addressing mode or indirect register addressing mode is used. When direct register addressing mode is used, the register address of one or more operands is directly provided by bits in the instruction.

In some embodiments, the 128-bit instruction format 710 includes an access/address mode field 726, which specifies an address mode and/or an access mode for the instruction. In one embodiment the access mode is used to define a data access alignment for the instruction. Some embodiments support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In one embodiment, the address mode portion of the access/address mode field 726 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some embodiments instructions are grouped based on opcode 712 bit-fields to simplify Opcode decode 740. For an 8-bit opcode, bits 4, 5, and 6 allow the execution unit to determine the type of opcode. The precise opcode grouping shown is merely an example. In some embodiments, a move and logic opcode group 742 includes data movement and logic instructions (e.g., move (mov), compare (cmp)). In some embodiments, move and logic group 742 shares the five most significant bits (MSB), where move (mov) instructions are in the form of 0000xxxxb and logic instructions are in the form of 0001xxxxb. A flow control instruction group 744 (e.g., call, jump (jmp)) includes instructions in the form of 0010xxxxb (e.g., 0x20). A miscellaneous instruction group 746 includes a mix of instructions, including synchronization instructions (e.g., wait, send) in the form of 0011xxxxb (e.g., 0x30). A parallel math instruction group 748 includes component-wise arithmetic instructions (e.g., add, multiply (mul)) in the form of 0100xxxxb (e.g., 0x40). The parallel math group 748 performs the arithmetic operations in parallel across data channels. The vector math group 750 includes arithmetic instructions (e.g., dp4) in the form of 0101xxxxb (e.g., 0x50). The vector math group performs arithmetic such as dot product calculations on vector operands. The illustrated opcode decode 740, in one embodiment, can be used to determine which portion of an execution unit will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

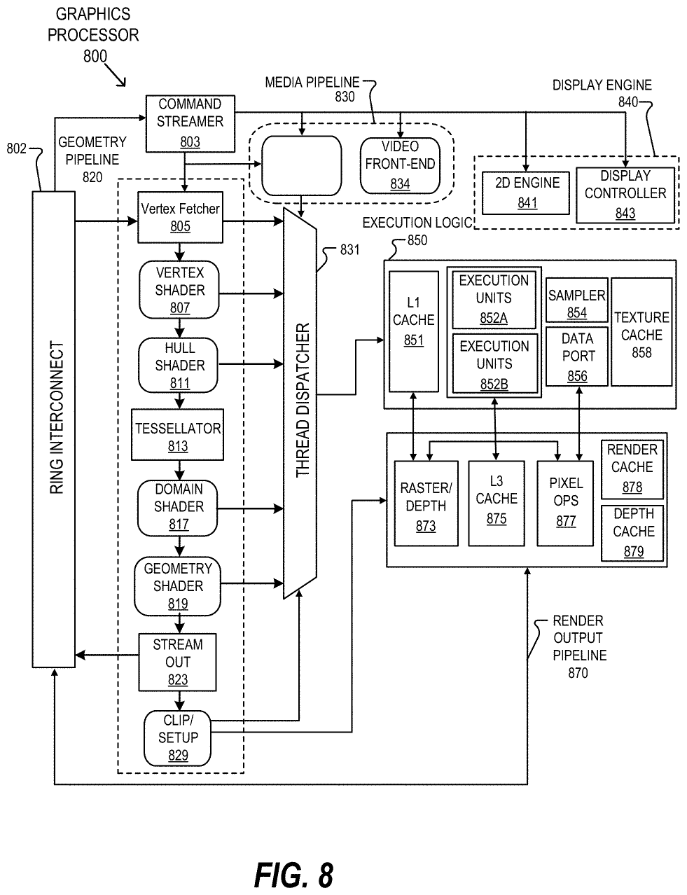

FIG. 8 is a block diagram of another embodiment of a graphics processor 800. Elements of FIG. 8 having the same reference numbers (or names) as the elements of any other figure herein can operate or function in any manner similar to that described elsewhere herein, but are not limited to such.

In some embodiments, graphics processor 800 includes a geometry pipeline 820, a media pipeline 830, a display engine 840, thread execution logic 850, and a render output pipeline 870. In some embodiments, graphics processor 800 is a graphics processor within a multi-core processing system that includes one or more general-purpose processing cores. The graphics processor is controlled by register writes to one or more control registers (not shown) or via commands issued to graphics processor 800 via a ring interconnect 802. In some embodiments, ring interconnect 802 couples graphics processor 800 to other processing components, such as other graphics processors or general-purpose processors. Commands from ring interconnect 802 are interpreted by a command streamer 803, which supplies instructions to individual components of the geometry pipeline 820 or the media pipeline 830.

In some embodiments, command streamer 803 directs the operation of a vertex fetcher 805 that reads vertex data from memory and executes vertex-processing commands provided by command streamer 803. In some embodiments, vertex fetcher 805 provides vertex data to a vertex shader 807, which performs coordinate space transformation and lighting operations to each vertex. In some embodiments, vertex fetcher 805 and vertex shader 807 execute vertex-processing instructions by dispatching execution threads to execution units 852A-852B via a thread dispatcher 831.

In some embodiments, execution units 852A-852B are an array of vector processors having an instruction set for performing graphics and media operations. In some embodiments, execution units 852A-852B have an attached L1 cache 851 that is specific for each array or shared between the arrays. The cache can be configured as a data cache, an instruction cache, or a single cache that is partitioned to contain data and instructions in different partitions.

In some embodiments, geometry pipeline 820 includes tessellation components to perform hardware-accelerated tessellation of 3D objects. In some embodiments, a programmable hull shader 811 configures the tessellation operations. A programmable domain shader 817 provides back-end evaluation of tessellation output. A tessellator 813 operates at the direction of hull shader 811 and contains special purpose logic to generate a set of detailed geometric objects based on a coarse geometric model that is provided as input to geometry pipeline 820. In some embodiments, if tessellation is not used, tessellation components (e.g., hull shader 811, tessellator 813, and domain shader 817) can be bypassed.

In some embodiments, complete geometric objects can be processed by a geometry shader 819 via one or more threads dispatched to execution units 852A-852B, or can proceed directly to the clipper 829. In some embodiments, the geometry shader operates on entire geometric objects, rather than vertices or patches of vertices as in previous stages of the graphics pipeline. If the tessellation is disabled, the geometry shader 819 receives input from the vertex shader 807. In some embodiments, geometry shader 819 is programmable by a geometry shader program to perform geometry tessellation if the tessellation units are disabled.

Before rasterization, a clipper 829 processes vertex data. The clipper 829 may be a fixed function clipper or a programmable clipper having clipping and geometry shader functions. In some embodiments, a rasterizer and depth test component 873 in the render output pipeline 870 dispatches pixel shaders to convert the geometric objects into per pixel representations. In some embodiments, pixel shader logic is included in thread execution logic 850. In some embodiments, an application can bypass the rasterizer and depth test component 873 and access un-rasterized vertex data via a stream out unit 823.

The graphics processor 800 has an interconnect bus, interconnect fabric, or some other interconnect mechanism that allows data and message passing amongst the major components of the processor. In some embodiments, execution units 852A-852B and associated logic units (e.g., L1 cache 851, sampler 854, texture cache 858, etc.) interconnect via a data port 856 to perform memory access and communicate with render output pipeline components of the processor. In some embodiments, sampler 854, caches 851, 858 and execution units 852A-852B each have separate memory access paths. In one embodiment the texture cache 858 can also be configured as a sampler cache.

In some embodiments, render output pipeline 870 contains a rasterizer and depth test component 873 that converts vertex-based objects into an associated pixel-based representation. In some embodiments, the rasterizer logic includes a windower/masker unit to perform fixed function triangle and line rasterization. An associated render cache 878 and depth cache 879 are also available in some embodiments. A pixel operations component 877 performs pixel-based operations on the data, though in some instances, pixel operations associated with 2D operations (e.g. bit block image transfers with blending) are performed by the 2D engine 841, or substituted at display time by the display controller 843 using overlay display planes. In some embodiments, a shared L3 cache 875 is available to all graphics components, allowing the sharing of data without the use of main system memory.

In some embodiments, graphics processor media pipeline 830 includes a media engine 837 and a video front-end 834. In some embodiments, video front-end 834 receives pipeline commands from the command streamer 803. In some embodiments, media pipeline 830 includes a separate command streamer. In some embodiments, video front-end 834 processes media commands before sending the command to the media engine 837. In some embodiments, media engine 837 includes thread spawning functionality to spawn threads for dispatch to thread execution logic 850 via thread dispatcher 831.

In some embodiments, graphics processor 800 includes a display engine 840. In some embodiments, display engine 840 is external to processor 800 and couples with the graphics processor via the ring interconnect 802, or some other interconnect bus or fabric. In some embodiments, display engine 840 includes a 2D engine 841 and a display controller 843. In some embodiments, display engine 840 contains special purpose logic capable of operating independently of the 3D pipeline. In some embodiments, display controller 843 couples with a display device (not shown), which may be a system integrated display device, as in a laptop computer, or an external display device attached via a display device connector.

In some embodiments, the geometry pipeline 820 and media pipeline 830 are configurable to perform operations based on multiple graphics and media programming interfaces and are not specific to any one application programming interface (API). In some embodiments, driver software for the graphics processor translates API calls that are specific to a particular graphics or media library into commands that can be processed by the graphics processor. In some embodiments, support is provided for the Open Graphics Library (OpenGL), Open Computing Language (OpenCL), and/or Vulkan graphics and compute API, all from the Khronos Group. In some embodiments, support may also be provided for the Direct3D library from the Microsoft Corporation. In some embodiments, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

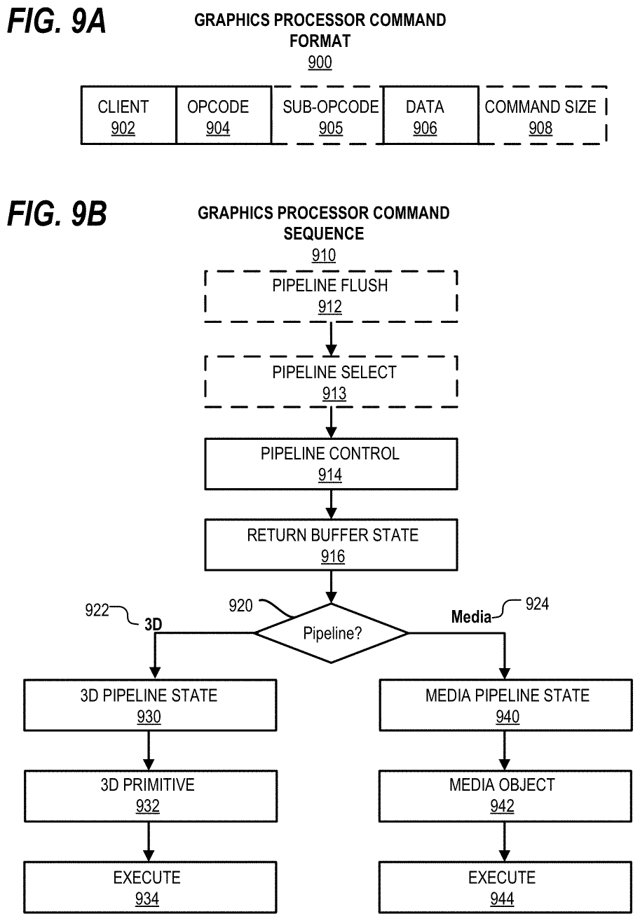

FIG. 9A is a block diagram illustrating a graphics processor command format 900 according to some embodiments. FIG. 9B is a block diagram illustrating a graphics processor command sequence 910 according to an embodiment. The solid lined boxes in FIG. 9A illustrate the components that are generally included in a graphics command while the dashed lines include components that are optional or that are only included in a sub-set of the graphics commands. The exemplary graphics processor command format 900 of FIG. 9A includes data fields to identify a client 902, a command operation code (opcode) 904, and data 906 for the command. A sub-opcode 905 and a command size 908 are also included in some commands.

In some embodiments, client 902 specifies the client unit of the graphics device that processes the command data. In some embodiments, a graphics processor command parser examines the client field of each command to condition the further processing of the command and route the command data to the appropriate client unit. In some embodiments, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 904 and, if present, sub-opcode 905 to determine the operation to perform. The client unit performs the command using information in data field 906. For some commands an explicit command size 908 is expected to specify the size of the command. In some embodiments, the command parser automatically determines the size of at least some of the commands based on the command opcode. In some embodiments commands are aligned via multiples of a double word. Other command formats can be used.

The flow diagram in FIG. 9B illustrates an exemplary graphics processor command sequence 910. In some embodiments, software or firmware of a data processing system that features an embodiment of a graphics processor uses a version of the command sequence shown to set up, execute, and terminate a set of graphics operations. A sample command sequence is shown and described for purposes of example only as embodiments are not limited to these specific commands or to this command sequence. Moreover, the commands may be issued as batch of commands in a command sequence, such that the graphics processor will process the sequence of commands in at least partially concurrence.

In some embodiments, the graphics processor command sequence 910 may begin with a pipeline flush command 912 to cause any active graphics pipeline to complete the currently pending commands for the pipeline. In some embodiments, the 3D pipeline 922 and the media pipeline 924 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some embodiments, pipeline flush command 912 can be used for pipeline synchronization or before placing the graphics processor into a low power state.

In some embodiments, a pipeline select command 913 is used when a command sequence requires the graphics processor to explicitly switch between pipelines. In some embodiments, a pipeline select command 913 is required only once within an execution context before issuing pipeline commands unless the context is to issue commands for both pipelines. In some embodiments, a pipeline flush command 912 is required immediately before a pipeline switch via the pipeline select command 913.

In some embodiments, a pipeline control command 914 configures a graphics pipeline for operation and is used to program the 3D pipeline 922 and the media pipeline 924. In some embodiments, pipeline control command 914 configures the pipeline state for the active pipeline. In one embodiment, the pipeline control command 914 is used for pipeline synchronization and to clear data from one or more cache memories within the active pipeline before processing a batch of commands.

In some embodiments, return buffer state commands 916 are used to configure a set of return buffers for the respective pipelines to write data. Some pipeline operations require the allocation, selection, or configuration of one or more return buffers into which the operations write intermediate data during processing. In some embodiments, the graphics processor also uses one or more return buffers to store output data and to perform cross thread communication. In some embodiments, the return buffer state 916 includes selecting the size and number of return buffers to use for a set of pipeline operations.

The remaining commands in the command sequence differ based on the active pipeline for operations. Based on a pipeline determination 920, the command sequence is tailored to the 3D pipeline 922 beginning with the 3D pipeline state 930 or the media pipeline 924 beginning at the media pipeline state 940.

The commands to configure the 3D pipeline state 930 include 3D state setting commands for vertex buffer state, vertex element state, constant color state, depth buffer state, and other state variables that are to be configured before 3D primitive commands are processed. The values of these commands are determined at least in part based on the particular 3D API in use. In some embodiments, 3D pipeline state 930 commands are also able to selectively disable or bypass certain pipeline elements if those elements will not be used.

In some embodiments, 3D primitive 932 command is used to submit 3D primitives to be processed by the 3D pipeline. Commands and associated parameters that are passed to the graphics processor via the 3D primitive 932 command are forwarded to the vertex fetch function in the graphics pipeline. The vertex fetch function uses the 3D primitive 932 command data to generate vertex data structures. The vertex data structures are stored in one or more return buffers. In some embodiments, 3D primitive 932 command is used to perform vertex operations on 3D primitives via vertex shaders. To process vertex shaders, 3D pipeline 922 dispatches shader execution threads to graphics processor execution units.

In some embodiments, 3D pipeline 922 is triggered via an execute 934 command or event. In some embodiments, a register write triggers command execution. In some embodiments execution is triggered via a ‘go’ or ‘kick’ command in the command sequence. In one embodiment, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some embodiments, the graphics processor command sequence 910 follows the media pipeline 924 path when performing media operations. In general, the specific use and manner of programming for the media pipeline 924 depends on the media or compute operations to be performed. Specific media decode operations may be offloaded to the media pipeline during media decode. In some embodiments, the media pipeline can also be bypassed and media decode can be performed in whole or in part using resources provided by one or more general-purpose processing cores. In one embodiment, the media pipeline also includes elements for general-purpose graphics processor unit (GPGPU) operations, where the graphics processor is used to perform SIMD vector operations using computational shader programs that are not explicitly related to the rendering of graphics primitives.

In some embodiments, media pipeline 924 is configured in a similar manner as the 3D pipeline 922. A set of commands to configure the media pipeline state 940 are dispatched or placed into a command queue before the media object commands 942. In some embodiments, commands for the media pipeline state 940 include data to configure the media pipeline elements that will be used to process the media objects. This includes data to configure the video decode and video encode logic within the media pipeline, such as encode or decode format. In some embodiments, commands for the media pipeline state 940 also support the use of one or more pointers to “indirect” state elements that contain a batch of state settings.

In some embodiments, media object commands 942 supply pointers to media objects for processing by the media pipeline. The media objects include memory buffers containing video data to be processed. In some embodiments, all media pipeline states must be valid before issuing a media object command 942. Once the pipeline state is configured and media object commands 942 are queued, the media pipeline 924 is triggered via an execute command 944 or an equivalent execute event (e.g., register write). Output from media pipeline 924 may then be post processed by operations provided by the 3D pipeline 922 or the media pipeline 924. In some embodiments, GPGPU operations are configured and executed in a similar manner as media operations.

### Graphics Software Architecture

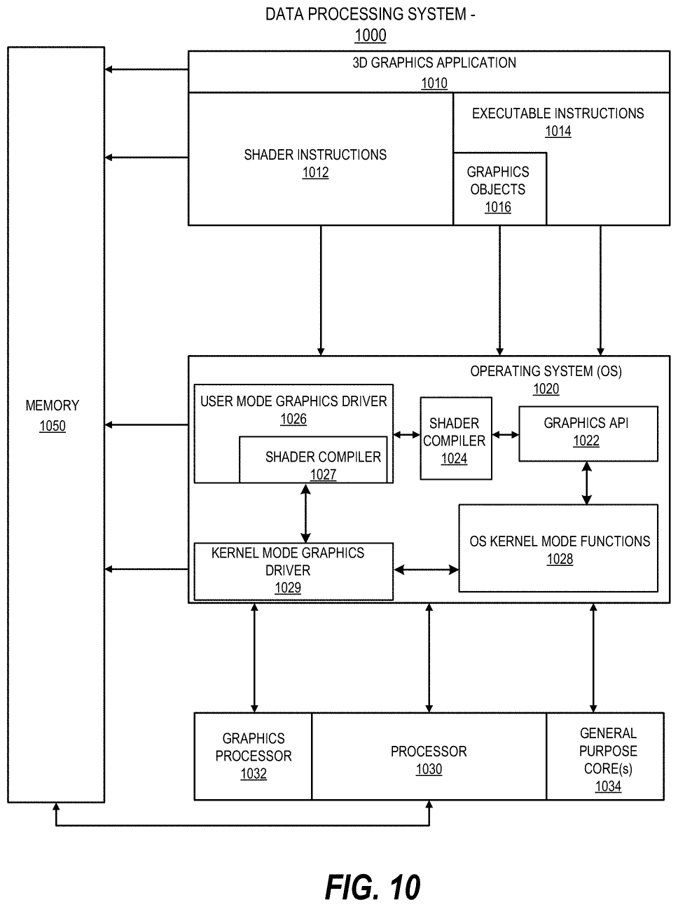

FIG. 10 illustrates an exemplary graphics software architecture for a data processing system 1000 according to some embodiments. In some embodiments, software architecture includes a 3D graphics application 1010, an operating system 1020, and at least one processor 1030. In some embodiments, processor 1030 includes a graphics processor 1032 and one or more general-purpose processor core(s) 1034. The graphics application 1010 and operating system 1020 each execute in the system memory 1050 of the data processing system.

In some embodiments, 3D graphics application 1010 contains one or more shader programs including shader instructions 1012. The shader language instructions may be in a high-level shader language, such as the High-Level Shader Language (HLSL) of Direct3D, the OpenGL Shader Language (GLSL), and so forth. The application also includes executable instructions 1014 in a machine language suitable for execution by the general-purpose processor core 1034. The application also includes graphics objects 1016 defined by vertex data.

In some embodiments, operating system 1020 is a Microsoft® Windows® operating system from the Microsoft Corporation, a proprietary UNIX-like operating system, or an open source UNIX-like operating system using a variant of the Linux kernel. The operating system 1020 can support a graphics API 1022 such as the Direct3D API, the OpenGL API, or the Vulkan API. When the Direct3D API is in use, the operating system 1020 uses a front-end shader compiler 1024 to compile any shader instructions 1012 in HLSL into a lower-level shader language. The compilation may be a just-in-time (JIT) compilation or the application can perform shader pre-compilation. In some embodiments, high-level shaders are compiled into low-level shaders during the compilation of the 3D graphics application 1010. In some embodiments, the shader instructions 1012 are provided in an intermediate form, such as a version of the Standard Portable Intermediate Representation (SPIR) used by the Vulkan API.

In some embodiments, user mode graphics driver 1026 contains a back-end shader compiler 1027 to convert the shader instructions 1012 into a hardware specific representation. When the OpenGL API is in use, shader instructions 1012 in the GLSL high-level language are passed to a user mode graphics driver 1026 for compilation. In some embodiments, user mode graphics driver 1026 uses operating system kernel mode functions 1028 to communicate with a kernel mode graphics driver 1029. In some embodiments, kernel mode graphics driver 1029 communicates with graphics processor 1032 to dispatch commands and instructions.

### IP Core Implementations

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

FIG. 11A is a block diagram illustrating an IP core development system 1100 that may be used to manufacture an integrated circuit to perform operations according to an embodiment. The IP core development system 1100 may be used to generate modular, re-usable designs that can be incorporated into a larger design or used to construct an entire integrated circuit (e.g., an SOC integrated circuit). A design facility 1130 can generate a software simulation 1110 of an IP core design in a high-level programming language (e.g., C/C++). The software simulation 1110 can be used to design, test, and verify the behavior of the IP core using a simulation model 1112. The simulation model 1112 may include functional, behavioral, and/or timing simulations. A register transfer level (RTL) design 1115 can then be created or synthesized from the simulation model 1112. The RTL design 1115 is an abstraction of the behavior of the integrated circuit that models the flow of digital signals between hardware registers, including the associated logic performed using the modeled digital signals. In addition to an RTL design 1115, lower-level designs at the logic level or transistor level may also be created, designed, or synthesized. Thus, the particular details of the initial design and simulation may vary.

The RTL design 1115 or equivalent may be further synthesized by the design facility into a hardware model 1120, which may be in a hardware description language (HDL), or some other representation of physical design data. The HDL may be further simulated or tested to verify the IP core design. The IP core design can be stored for delivery to a 3rd party fabrication facility 1165 using non-volatile memory 1140 (e.g., hard disk, flash memory, or any non-volatile storage medium). Alternatively, the IP core design may be transmitted (e.g., via the Internet) over a wired connection 1150 or wireless connection 1160. The fabrication facility 1165 may then fabricate an integrated circuit that is based at least in part on the IP core design. The fabricated integrated circuit can be configured to perform operations in accordance with at least one embodiment described herein.

FIG. 11B illustrates a cross-section side view of an integrated circuit package assembly 1170, according to some embodiments described herein. The integrated circuit package assembly 1170 illustrates an implementation of one or more processor or accelerator devices as described herein. The package assembly 1170 includes multiple units of hardware logic 1172, 1174 connected to a substrate 1180. The logic 1172, 1174 may be implemented at least partly in configurable logic or fixed-functionality logic hardware, and can include one or more portions of any of the processor core(s), graphics processor(s), or other accelerator devices described herein. Each unit of logic 1172, 1174 can be implemented within a semiconductor die and coupled with the substrate 1180 via an interconnect structure 1173. The interconnect structure 1173 may be configured to route electrical signals between the logic 1172, 1174 and the substrate 1180, and can include interconnects such as, but not limited to bumps or pillars. In some embodiments, the interconnect structure 1173 may be configured to route electrical signals such as, for example, input/output (I/O) signals and/or power or ground signals associated with the operation of the logic 1172, 1174. In some embodiments, the substrate 1180 is an epoxy-based laminate substrate. The substrate 1180 may include other suitable types of substrates in other embodiments. The package assembly 1170 can be connected to other electrical devices via a package interconnect 1183. The package interconnect 1183 may be coupled to a surface of the substrate 1180 to route electrical signals to other electrical devices, such as a motherboard, other chipset, or multi-chip module.

In some embodiments, the units of logic 1172, 1174 are electrically coupled with a bridge 1182 that is configured to route electrical signals between the logic 1172, 1174. The bridge 1182 may be a dense interconnect structure that provides a route for electrical signals. The bridge 1182 may include a bridge substrate composed of glass or a suitable semiconductor material. Electrical routing features can be formed on the bridge substrate to provide a chip-to-chip connection between the logic 1172, 1174.

Although two units of logic 1172, 1174 and a bridge 1182 are illustrated, embodiments described herein may include more or fewer logic units on one or more dies. The one or more dies may be connected by zero or more bridges, as the bridge 1182 may be excluded when the logic is included on a single die. Alternatively, multiple dies or units of logic can be connected by one or more bridges. Additionally, multiple logic units, dies, and bridges can be connected together in other possible configurations, including three-dimensional configurations.

FIG. 11C illustrates a package assembly 1190 that includes multiple units of hardware logic chiplets connected to a substrate 1180 (e.g., base die). A graphics processing unit, parallel processor, and/or compute accelerator as described herein can be composed from diverse silicon chiplets that are separately manufactured. In this context, a chiplet is an at least partially packaged integrated circuit that includes distinct units of logic that can be assembled with other chiplets into a larger package. A diverse set of chiplets with different IP core logic can be assembled into a single device. Additionally, the chiplets can be integrated into a base die or base chiplet using active interposer technology. The concepts described herein enable the interconnection and communication between the different forms of IP within the GPU. IP cores can be manufactured using different process technologies and composed during manufacturing, which avoids the complexity of converging multiple IPs, especially on a large SoC with several flavors IPs, to the same manufacturing process. Enabling the use of multiple process technologies improves the time to market and provides a cost-effective way to create multiple product SKUs. Additionally, the disaggregated IPs are more amenable to being power gated independently, components that are not in use on a given workload can be powered off, reducing overall power consumption.

The hardware logic chiplets can include special purpose hardware logic chiplets 1172, logic or I/O chiplets 1174, and/or memory chiplets 1175. The hardware logic chiplets 1172 and logic or I/O chiplets 1174 may be implemented at least partly in configurable logic or fixed-functionality logic hardware and can include one or more portions of any of the processor core(s), graphics processor(s), parallel processors, or other accelerator devices described herein. The memory chiplets 1175 can be DRAM (e.g., GDDR, HBM) memory or cache (SRAM) memory.

Each chiplet can be fabricated as separate semiconductor die and coupled with the substrate 1180 via an interconnect structure 1173. The interconnect structure 1173 may be configured to route electrical signals between the various chiplets and logic within the substrate 1180. The interconnect structure 1173 can include interconnects such as, but not limited to bumps or pillars. In some embodiments, the interconnect structure 1173 may be configured to route electrical signals such as, for example, input/output (I/O) signals and/or power or ground signals associated with the operation of the logic, I/O and memory chiplets.

In some embodiments, the substrate 1180 is an epoxy-based laminate substrate. The substrate 1180 may include other suitable types of substrates in other embodiments. The package assembly 1190 can be connected to other electrical devices via a package interconnect 1183. The package interconnect 1183 may be coupled to a surface of the substrate 1180 to route electrical signals to other electrical devices, such as a motherboard, other chipset, or multi-chip module.

In some embodiments, a logic or I/O chiplet 1174 and a memory chiplet 1175 can be electrically coupled via a bridge 1187 that is configured to route electrical signals between the logic or I/O chiplet 1174 and a memory chiplet 1175. The bridge 1187 may be a dense interconnect structure that provides a route for electrical signals. The bridge 1187 may include a bridge substrate composed of glass or a suitable semiconductor material. Electrical routing features can be formed on the bridge substrate to provide a chip-to-chip connection between the logic or I/O chiplet 1174 and a memory chiplet 1175. The bridge 1187 may also be referred to as a silicon bridge or an interconnect bridge. For example, the bridge 1187, in some embodiments, is an Embedded Multi-die Interconnect Bridge (EMIB). In some embodiments, the bridge 1187 may simply be a direct connection from one chiplet to another chiplet.

The substrate 1180 can include hardware components for I/O 1191, cache memory 1192, and other hardware logic 1193. A fabric 1185 can be embedded in the substrate 1180 to enable communication between the various logic chiplets and the logic 1191, 1193 within the substrate 1180. In one embodiment, the I/O 1191, fabric 1185, cache, bridge, and other hardware logic 1193 can be integrated into a base die that is layered on top of the substrate 1180.

In various embodiments a package assembly 1190 can include fewer or greater number of components and chiplets that are interconnected by a fabric 1185 or one or more bridges 1187. The chiplets within the package assembly 1190 may be arranged in a 3D or 2.5D arrangement. In general, bridge structures 1187 may be used to facilitate a point to point interconnect between, for example, logic or I/O chiplets and memory chiplets. The fabric 1185 can be used to interconnect the various logic and/or I/O chiplets (e.g., chiplets 1172, 1174, 1191, 1193). with other logic and/or I/O chiplets. In one embodiment, the cache memory 1192 within the substrate can act as a global cache for the package assembly 1190, part of a distributed global cache, or as a dedicated cache for the fabric 1185.

FIG. 11D illustrates a package assembly 1194 including interchangeable chiplets 1195, according to an embodiment. The interchangeable chiplets 1195 can be assembled into standardized slots on one or more base chiplets 1196, 1198. The base chiplets 1196, 1198 can be coupled via a bridge interconnect 1197, which can be similar to the other bridge interconnects described herein and may be, for example, an EMIB. Memory chiplets can also be connected to logic or I/O chiplets via a bridge interconnect. I/O and logic chiplets can communicate via an interconnect fabric. The base chiplets can each support one or more slots in a standardized format for one of logic or I/O or memory/cache.

In one embodiment, SRAM and power delivery circuits can be fabricated into one or more of the base chiplets 1196, 1198, which can be fabricated using a different process technology relative to the interchangeable chiplets 1195 that are stacked on top of the base chiplets. For example, the base chiplets 1196, 1198 can be fabricated using a larger process technology, while the interchangeable chiplets can be manufactured using a smaller process technology. One or more of the interchangeable chiplets 1195 may be memory (e.g., DRAM) chiplets. Different memory densities can be selected for the package assembly 1194 based on the power, and/or performance targeted for the product that uses the package assembly 1194. Additionally, logic chiplets with a different number of type of functional units can be selected at time of assembly based on the power, and/or performance targeted for the product. Additionally, chiplets containing IP logic cores of differing types can be inserted into the interchangeable chiplet slots, enabling hybrid processor designs that can mix and match different technology IP blocks.

### Exemplary System on a Chip Integrated Circuit

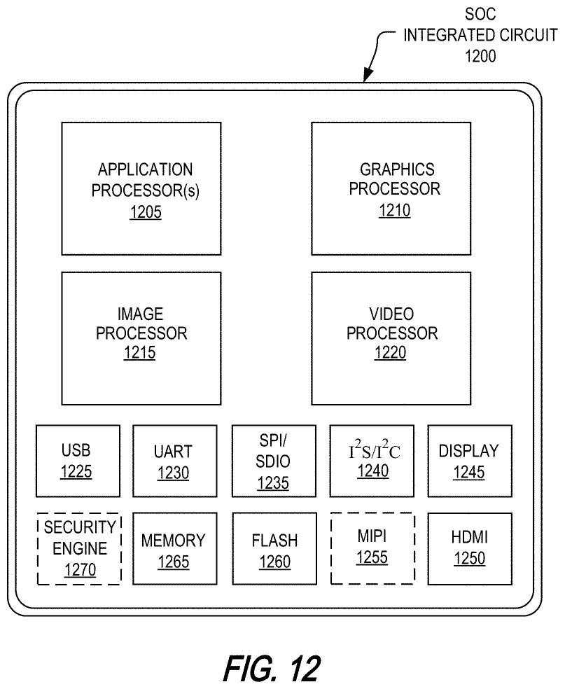

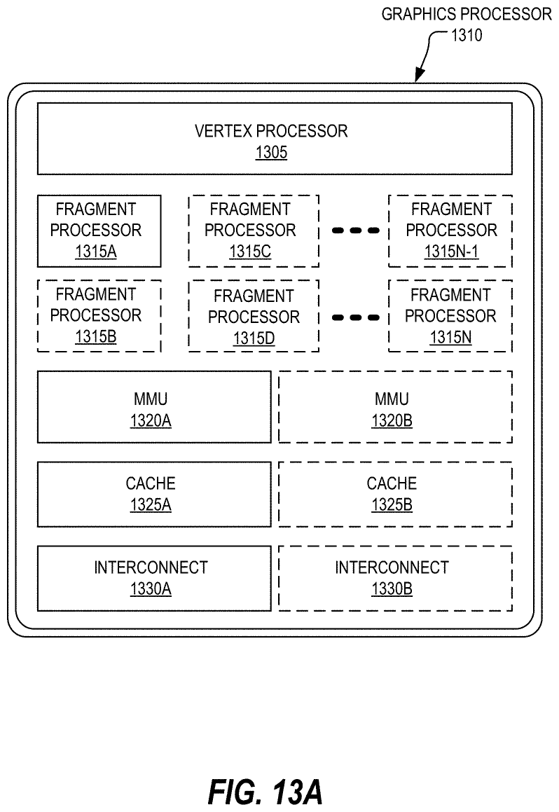

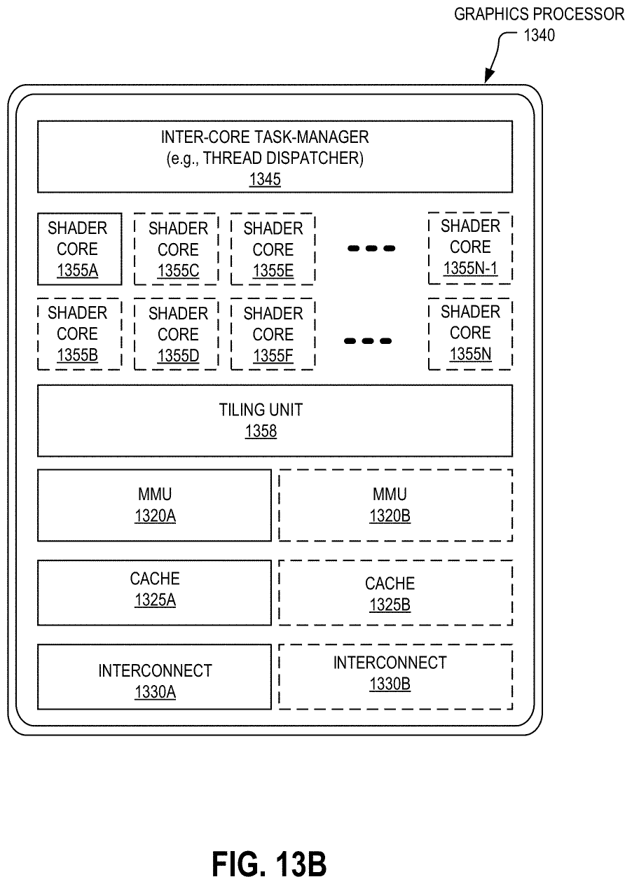

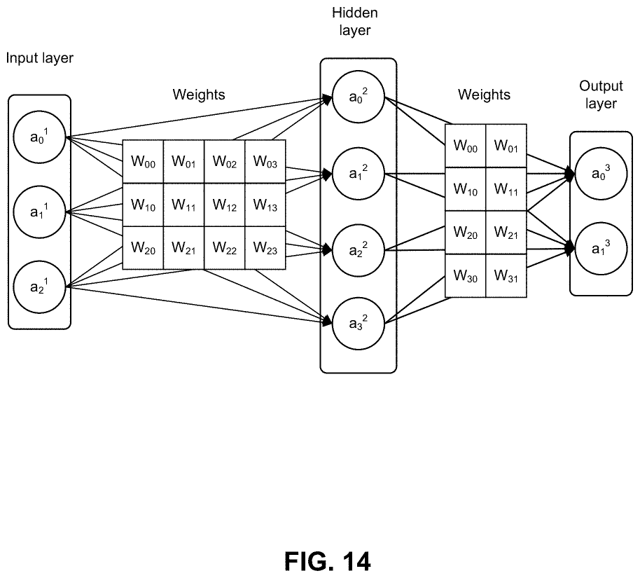

FIGS. 12 and 13A-13B illustrate exemplary integrated circuits and associated graphics processors that may be fabricated using one or more IP cores, according to various embodiments described herein. In addition to what is illustrated, other logic and circuits may be included, including additional graphics processors/cores, peripheral interface controllers, or general-purpose processor cores.

FIG. 12 is a block diagram illustrating an exemplary system on a chip integrated circuit 1200 that may be fabricated using one or more IP cores, according to an embodiment. Exemplary integrated circuit 1200 includes one or more application processor(s) 1205 (e.g., CPUs), at least one graphics processor 1210, and may additionally include an image processor 1215 and/or a video processor 1220, any of which may be a modular IP core from the same or multiple different design facilities. Integrated circuit 1200 includes peripheral or bus logic including a USB controller 1225, UART controller 1230, an SPI/SDIO controller 1235, and an I2S/I2C controller 1240. Additionally, the integrated circuit can include a display device 1245 coupled to one or more of a high-definition multimedia interface (HDMI) controller 1250 and a mobile industry processor interface (MIPI) display interface 1255. Storage may be provided by a flash memory subsystem 1260 including flash memory and a flash memory controller. Memory interface may be provided via a memory controller 1265 for access to SDRAM or SRAM memory devices. Some integrated circuits additionally include an embedded security engine 1270.

FIGS. 13A-13B are block diagrams illustrating exemplary graphics processors for use within an SoC, according to embodiments described herein. FIG. 13A illustrates an exemplary graphics processor 1310 of a system on a chip integrated circuit that may be fabricated using one or more IP cores, according to an embodiment. FIG. 13B illustrates an additional exemplary graphics processor 1340 of a system on a chip integrated circuit that may be fabricated using one or more IP cores, according to an embodiment. Graphics processor 1310 of FIG. 13A is an example of a low power graphics processor core. Graphics processor 1340 of FIG. 13B is an example of a higher performance graphics processor core. Each of the graphics processors 1310, 1340 can be variants of the graphics processor 1210 of FIG. 12.

As shown in FIG. 13A, graphics processor 1310 includes a vertex processor 1305 and one or more fragment processor(s) 1315A-1315N (e.g., 1315A, 1315B, 1315C, 1315D, through 1315N−1, and 1315N). Graphics processor 1310 can execute different shader programs via separate logic, such that the vertex processor 1305 is optimized to execute operations for vertex shader programs, while the one or more fragment processor(s) 1315A-1315N execute fragment (e.g., pixel) shading operations for fragment or pixel shader programs. The vertex processor 1305 performs the vertex processing stage of the 3D graphics pipeline and generates primitives and vertex data. The fragment processor(s) 1315A-1315N use the primitive and vertex data generated by the vertex processor 1305 to produce a framebuffer that is displayed on a display device. In one embodiment, the fragment processor(s) 1315A-1315N are optimized to execute fragment shader programs as provided for in the OpenGL API, which may be used to perform similar operations as a pixel shader program as provided for in the Direct 3D API.

Graphics processor 1310 additionally includes one or more memory management units (MMUs) 1320A-1320B, cache(s) 1325A-1325B, and circuit interconnect(s) 1330A-1330B. The one or more MMU(s) 1320A-1320B provide for virtual to physical address mapping for the graphics processor 1310, including for the vertex processor 1305 and/or fragment processor(s) 1315A-1315N, which may reference vertex or image/texture data stored in memory, in addition to vertex or image/texture data stored in the one or more cache(s) 1325A-1325B. In one embodiment the one or more MMU(s) 1320A-1320B may be synchronized with other MMUs within the system, including one or more MMUs associated with the one or more application processor(s) 1205, image processor 1215, and/or video processor 1220 of FIG. 12, such that each processor 1205-1220 can participate in a shared or unified virtual memory system. The one or more circuit interconnect(s) 1330A-1330B enable graphics processor 1310 to interface with other IP cores within the SoC, either via an internal bus of the SoC or via a direct connection, according to embodiments.

As shown FIG. 13B, graphics processor 1340 includes the one or more MMU(s) 1320A-1320B, cache(s) 1325A-1325B, and circuit interconnect(s) 1330A-1330B of the graphics processor 1310 of FIG. 13A. Graphics processor 1340 includes one or more shader core(s) 1355A-1355N (e.g., 1455A, 1355B, 1355C, 1355D, 1355E, 1355F, through 1355N−1, and 1355N), which provides for a unified shader core architecture in which a single core or type or core can execute all types of programmable shader code, including shader program code to implement vertex shaders, fragment shaders, and/or compute shaders. The exact number of shader cores present can vary among embodiments and implementations. Additionally, graphics processor 1340 includes an inter-core task manager 1345, which acts as a thread dispatcher to dispatch execution threads to one or more shader cores 1355A-1355N and a tiling unit 1358 to accelerate tiling operations for tile-based rendering, in which rendering operations for a scene are subdivided in image space, for example to exploit local spatial coherence within a scene or to optimize use of internal caches.

A machine learning algorithm is an algorithm that can learn based on a set of data. For example, machine learning algorithms can be designed to model high-level abstractions within a data set. For example, image recognition algorithms can be used to determine which of several categories to which a given input belong; regression algorithms can output a numerical value given an input; and pattern recognition algorithms can be used to generate translated text or perform text to speech and/or speech recognition.

An exemplary type of machine learning algorithm is a neural network. There are many types of neural networks, such as a feedforward network. A feedforward network may be implemented as an acyclic graph in which the nodes are arranged in layers. A feedforward network topology can include an input layer and an output layer that are separated by at least one hidden layer. The hidden layer can transform an input received by the input layer into a representation that is useful for generating output in the output layer. The network nodes can be fully connected via edges to the nodes in adjacent layers, but there may be no edges between nodes within each layer. Data received at the nodes of an input layer of a feedforward network can be propagated (e.g., “fed forward”) to the nodes of the output layer via an activation function that calculates the states of the nodes of each successive layer in the network based on coefficients (“weights”) respectively associated with each of the edges connecting the layers. Depending on the specific model being represented by the algorithm being executed, the output from the neural network algorithm can take various forms.

Before a machine learning algorithm can be used to model a particular problem, the algorithm can be trained using a training data set. Training a neural network can involve selecting a network topology, using a set of training data representing a problem being modeled by the network, and adjusting the weights until the network model performs with a minimal error for all instances of the training data set. For example, during a supervised learning training process for a neural network, the output produced by the network in response to the input representing an instance in a training data set can be compared to the “correct” labeled output for that instance, an error signal representing the difference between the output and the labeled output is calculated, and the weights associated with the connections are adjusted to minimize that error as the error signal is backward propagated through the layers of the network. The neural network can be considered “trained” when the errors for each of the outputs generated from the instances of the training data set are minimized.

The accuracy of a machine learning algorithm can be affected significantly by the quality of the data set used to train the algorithm. The training process can be computationally intensive and may require a significant amount of time on a conventional general-purpose processor. Accordingly, parallel processing hardware can be used to train many types of machine learning algorithms. This is particularly useful for optimizing the training of neural networks, as the computations performed in adjusting the coefficients in neural networks lend themselves naturally to parallel implementations. Specifically, many machine learning algorithms and software applications can be adapted to make use of the parallel processing hardware within general-purpose graphics processing devices.

FIG. 14 depicts an example of a fully-connected neural network, although embodiments are not limited to use in this example. A fully-connected neural network includes neurons aᵢ¹ (compute unit) connected with each other through synapses Wᵢⱼ (memory unit). Assuming the number of neurons in the i^{th} fully connected layer of DNN to be N₁ⁱ, then the number of synapse connections between i^{th} and i+1^{th} fully connected layer is N₁ⁱ×N₁ⁱ⁺¹. Although one hidden layer is shown, multiple hidden layers can be used.

After a feed forward with full applied weights, there can be a comparison of an output with a target output, error back propagation, determination of the delta weights/gradient, and generation of replacement real weight values. Back propagation of error between output and target (e.g., loss function) can be determined using root mean square error, hinge loss and stochastic gradient descent can be applied to correct for error that is a function, determination of a minimum (derivative) of loss function for each parameter. Training of weight matrices of one or more hidden layers can be achieved through other techniques including but not limited to: evolution strategies proposed by OpenAI, convex optimization, discrete optimization, proximal back propagation, direct feedback alignment, genetic algorithms, Markov chain Monte Carlo (MCMC), simulated annealing, simplex, Broyden-Fletcher-Goldfarb-Shanno (BFGS), grid search, among others.

Data center traffic patterns can be characterized into two general key buckets: small (e.g., few kilobytes) latency-sensitive “mice” traffic flows that often represent request queries, or sub-queries for workloads such as WebSearch or large “elephant” sized flows (e.g., multiple megabytes) often representing throughput-centric workloads such as storage. Some solutions separate mice and elephant flows into different Traffic Classes or Virtual Channels and separating mice and elephant flows into different logical queues, Virtual Channels (VCs), or Virtual Lanes (VL). For example use of VCs or VLs can allow multiple independent data streams to be multiplexed onto a single physical link to provide differentiated services (QoS) on a packet-boundary basis. In some examples, InfiniBand consistent architectures can be used to support VCs and VLs. Utilization of different VCs or Traffic Classes (TCs) is a technique commonly employed to provide Quality-of-Service (QoS) or used to ensure deadlock free routing in some topologies. Decoupling mice and elephant traffic can provide lower latency for mice flows as mice flows are less likely to be blocked or stalled behind larger elephant messages even though the physical bandwidth is still shared between mice and elephant flows. Decoupling the two traffic types further enables a set of arbitration prioritization techniques that can be applied at a network device (e.g., switch) to prioritize the VC associated with mice traffic (e.g., using Weighted Round-Robin (WRR)).

However, classification of traffic patterns into two categories for emerging AI and Deep-Learning (DL) models and use-cases may lead to increased latency in AI or DL related traffic. With AI training data, medium size messages (e.g., 1 MB-100s of MB) can be sent and those messages may not be considered mice flows and not handled as latency sensitive.

For example, AI training workloads can include two distinct types of algorithms used to train the model parameters, namely, Data-Parallel and Model-Parallel. Data-Parallel divides the training dataset among a set of workers (endpoints) whereas Model-Parallel attempts to partition different stages of a workload onto different workers and the same data traverses the different stages, as a software pipelined workload.

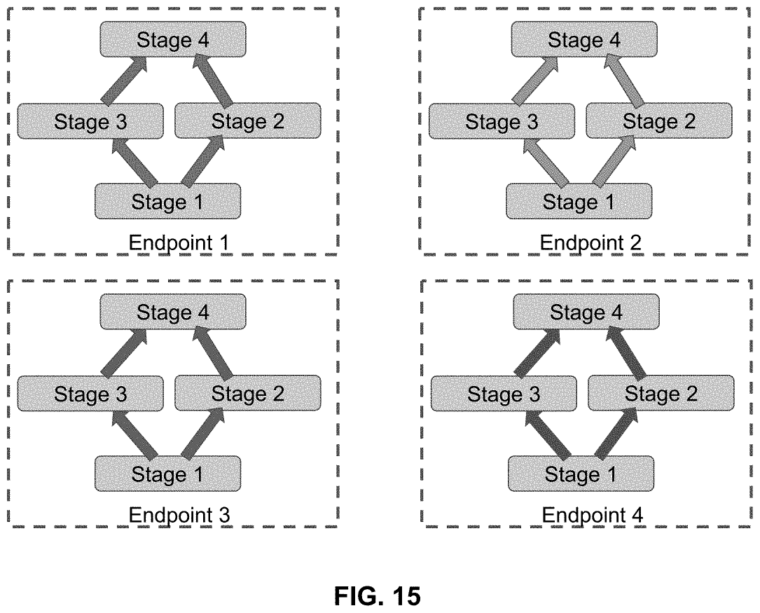

FIG. 15 depicts an example of data-parallelism. In the case of data-parallelism, the latency-sensitiveness of the workload's communication arises during the back-propagation phase when the feedback adjustment tunes the analyzing layers to minimize prediction error, also known as the gradients. Each endpoint can be responsible for processing the entirety of a subset of the overall training data, represented by arrows. A previous layer can stall until these gradients arrive from a layer ahead for use in a subsequent iteration of data computation. Latency in availability of gradients can introduce latency in a completion of neural network training. In data-parallelism, weights can be communicated in the form of an AllReduce collective, which can vary in size from approximately 1 KB to 100 MB. An AllReduce collective can reduce target arrays to a single array and returns the resultant array to multiple processes. A large range variation in size of latency sensitive communications coupled with use of mice or elephant flow distinction may lead to unacceptable latency of transfer of weights for DL workloads.

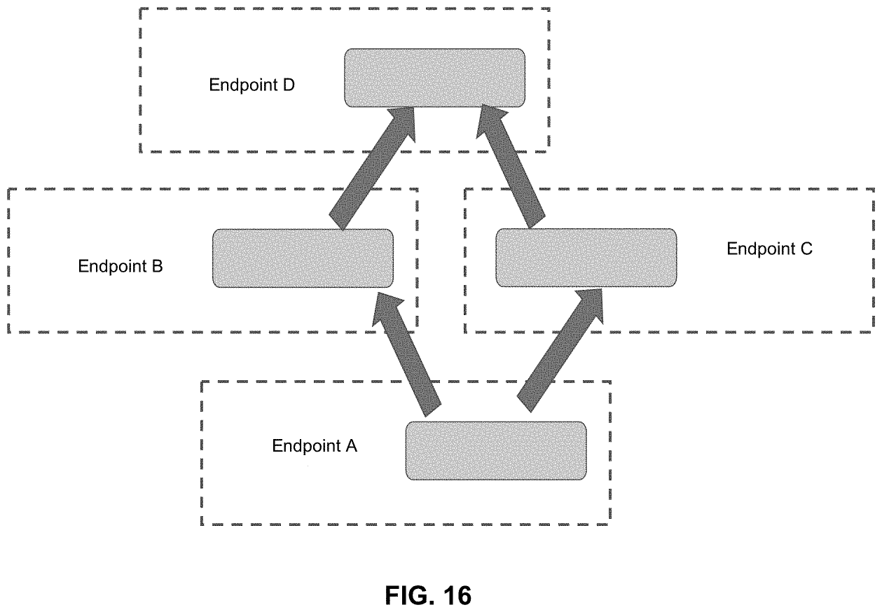

FIG. 16 depicts an example of model parallelism. The arrows can represent an entire training data-set and boxes can represent instantiations of a portion of a model. Execution of AI training workloads may not occur in isolation (e.g., in DCNs) and both AI training and AI inference could execute concurrently whereby multiple sets of different AI training applications and/or models may execute concurrently. In addition, re-training may occur as input datasets continue to grow and evolve which can involve periodic re-learning to ensure the training algorithm remains well fitted.

Sensitivity to latency can arise in a critical path using model parallelism because the model parameters that are spliced across endpoints can be aggregated before any forward progress can be made within forward propagation. For example, given 4 endpoints (A, B, C, D) (not depicted), a neural network with 4 layers (L0-L3) may be partitioned such that L0 is completely on Endpoint A, and L1 is spliced across Endpoints B and C, while L2 and L3 are on Endpoint D. In this case, the processing of L1 cannot start until Endpoints B and C receive data from Endpoint A. Since the model is spliced at Endpoints B and C, Endpoint D needs to receive aggregated data from Endpoints B and C before its processing of layers L2 and L3 can begin. In this scenario, there are multiple points during forward propagation which are latency sensitive.

Various embodiments prioritize AI and ML related data (e.g., gradients or model parameters) based on ordering of data reads or writes in a multi-layer neural network (NN) or accumulation operations and based on network conditions (e.g., congestion or lack of congestion) between nodes that process data from other nodes. Compute-communication characteristics of Deep Learning workloads can provide a priori knowledge of an order of data processing and accordingly, an order in which communication messages that include data are to be prioritized for transmission and/or prioritized for processing.

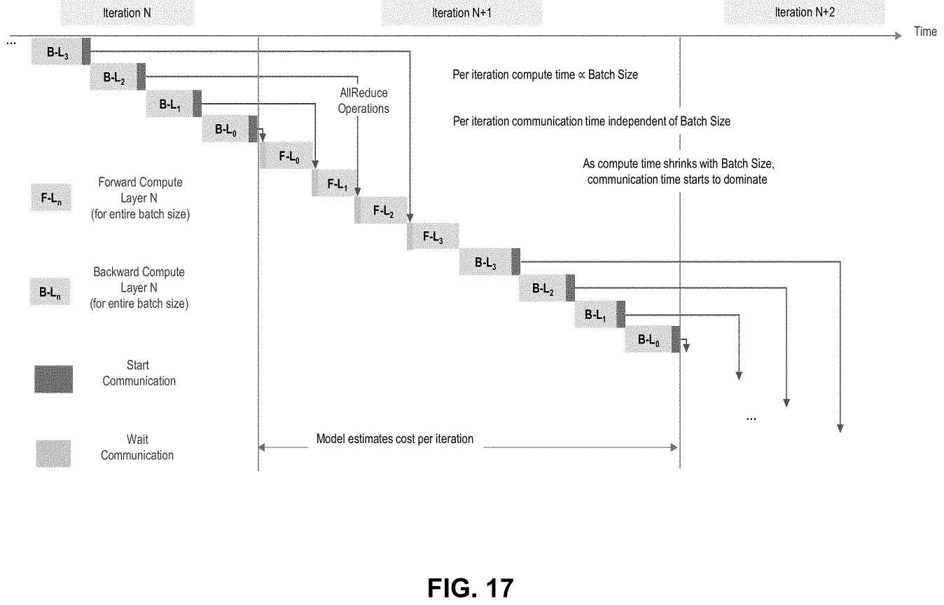

FIG. 17 provides an illustration of communication dependency for forward and backward propagation communication for a data-parallel Deep Learning workload. For example, a convolutional neural network can be any number of layers deep (e.g., 50 layers deep such as Resnet50). In the case of model parallelism, the latency sensitive component of the workload can be even further pronounced, and not necessarily limited to just back-propagation of a model's weights. In data-parallelism, every worker operated on independent data-partitions and the cross-worker synchronization occurred with respect to the back-propagation of weights. In model-parallelism, communication-bound synchronization can occur between certain endpoints (workers) during the forward propagation. Because message sizes used for forward and back-propagation of weights vary widely and do not decompose into mice or elephant size flows, network solutions that utilize prioritization based on mice or elephant size flow may not provide adequate prioritization when optimizing training workloads in DCNs.

A network performance gap may continue to widen as workload models continue to evolve as data scientists further explore hybrid models (e.g., part data-parallel, part model-parallel) that are ever growing in terms of parameter size.

Various embodiments can determine priority of packet transmission and/or packet processing of machine learning weight and gradient data in connection with machine learning model training. Various embodiments determine packet transmission priority or packet transmission order to reduce latency of availability of data at a receiver by considering two or more of data dependency between application layers of a machine learning model, size of message to transmit for processing, and network congestion (e.g., network interface or switch congestion).

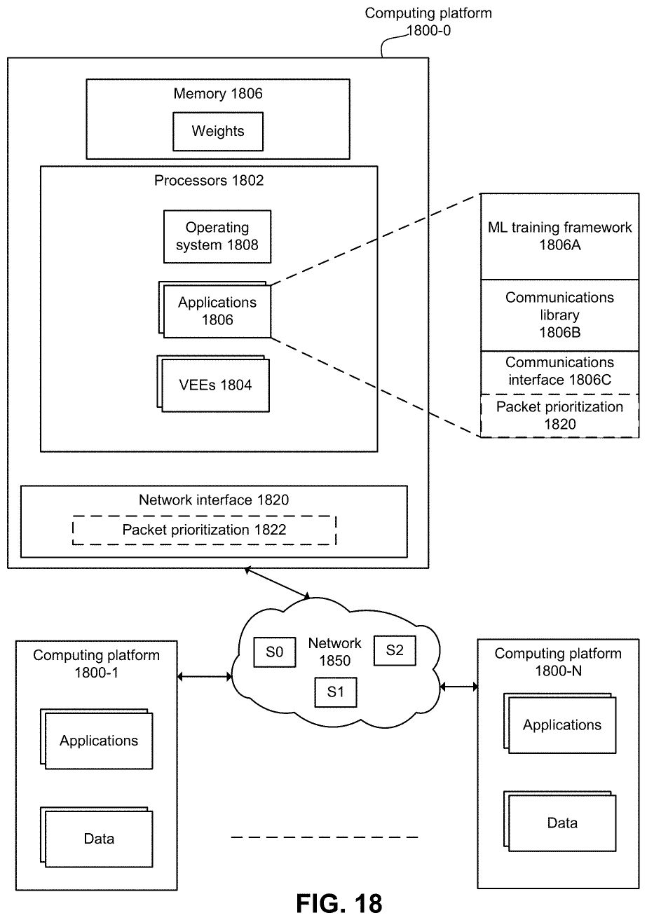

FIG. 18 depicts an overview of various embodiments. In this example, computing platform 1800 can represent any or all of computing platforms 1800-0 to 1800-N, wherein N≥1. Computing platform 1800-0 can use processors 1802 to perform computation and execute applications, operating system, and drivers as well as virtual machine (VMs) or container environments. Processors 1802 can include one or more of: central processing unit (CPU), core, graphics processing unit (GPU), general purpose graphics processing unit (GPGPU), field programmable gate array (FPGA), High-Density Deep Learning (HDDL) compute engines (or other devices configured for machine learning or inference related operations), or Visual Compute Accelerator (VCA) (or other image, audio, or video processor).

Virtual execution environments (VEEs) 1804 can include any environment that allows processes, operating systems, applications or other software to share computing resources (e.g., processors, networking, storage, and memory) while permitting data security and separation. A virtual execution environment can include a virtual machine and/or a container. A virtual machine can be software that runs an operating system and one or more applications. A virtual machine can be defined by specification, configuration files, virtual disk file, non-volatile random access memory (NVRAM) setting file, and the log file and is backed by the physical resources of a host computing platform. A container can be a software package of applications, configurations and dependencies so the applications run reliably on one computing environment to another. Containers can share an operating system installed on the server platform and run as isolated processes.

Applications 1806 can include machine learning features that are trained or make an inference according to a DL, ML, or AI framework 1806A. For example, any type of inferences can be made such as, but not limited to, image classification, image detection, speech recognition, and other inferences. Examples of framework 1806A include TensorFlow (Google), PyTorch (Facebook), MXNet (Microsoft), Keras, NVIDIA CUDA®, Turing-NLG, and Megatron-LM. Framework 1806A can dynamically schedule layers including activation functions of neural network such as a computational graph for DL workloads. Framework 1806A can determine inter-layer data dependencies (e.g., producer-consumer relationships) and layer execution schedule and determine an approximate compute time in each layer.

Communications library 1806B can enable distributed communication via underlying application program interface (API) calls using communications interface 1806C and can measure communication time over network 1850. Communications library 1806B can measure communications times through a network to a destination such as baseline round trip time (RTT) or Bandwidth-Delay-Product (BDP). For example, communications library 1806B can be implemented using Horovod, nVidia's NCCL, Intel's MLSL, or others. Communications interface 1806C can create or inspect packets to or from the network interface controller (NIC) 1820. Communications interface 1806C can inspect received packets to identify congestion for example by identifications of indications or levels of congestion in congestion notifications such as Explicit Congestion Notification (ECN), Priority-based Flow Control (PFC), pause-based Xon/Xoff, Quantized Congestion Notification (QCN), IEEE 802.1 Congestion Notification Packet (CNP), in-network telemetry (INT), In-situ Operations, Administration, and Maintenance (IOAM) queue congestion information from a congested switch, or Time to live (TTL) (e.g., lifetime of data in a computer or network).

Communications interface 1806C can be based on Data Plane Development Kit (DPDK) or communications APIs including Message Passing Interface (MPI), Symmetric Hierarchical Memory Access (SHMEM), and Unified Parallel C (UPC). These processes can use a class of operations called “Collectives,” which can be used to enable communication and synchronization between multiple processes on multiple nodes. These collective operations can be used by multiple computers in a High-Performance Computing (HPC) cluster or cloud over sockets.

For example, a number of iterations of a neural network can be run to determine neural network layer schedule and dependencies, layer compute and communication characteristics as well as network congestion. An iteration can include one complete forward and backward pass through all the defined layers. Training workloads can take many more iterations (e.g., hundreds of thousands) to reach time-to-solution. After an entire schedule between the layers is constructed, the schedule may remain steady to ensure that application 1806 can leverage this static knowledge to decide opportunities for acceleration. In some examples, application 1806 can utilize one or more of the following metrics to assign relative priorities across the different communication messages as described herein.

For priority of message based on layer number, applications 1806 can tag messages with relative priority levels depending on the layer number the message corresponds to. For instance, messages originating at layer i+1 may be more latency sensitive than messages originating at layer i during the back-propagation phase due to layer i+1 backpropagation not being able to execute until weights from layer i are received. As an example, in the case if there were 4 priority levels exposed and 100 layers in the AI-training application with available priority levels 0-3 (0 indicates the highest priority), ML training framework 1806A could apply the following priority levels: layers 99-75 are assigned priority P3, layers 74-51 are assigned priority P2, layers 49-25 are assigned priority P1, and layers 24-0 are assigned priority P0.

Given an a priori knowledge of a workload's compute-communication characteristics, applications 1806 can combine a layer-by-layer grouping schedule with knowledge of future messages that are going to be issued within a time window. The time window can depend on the compute characteristics of the platform that the workload is executing on. For example, if there are 4 levels of groupings exposed, the hint generation mechanism could determine that there are repeating fully connected (FC) layers that periodically issue the largest messages and hence are to be overlapped with layers that have high compute-density in order for message transmission or compute latency to be fully hidden by providing highest priority to transmission of such messages so that any stalls waiting for such messages can be reduced. Applications 1806 could assign these largest messages or largest compute time to the same priority (e.g., high) grouping. For example, layer 99-97 can be assigned a low priority, layer 96 can be assigned a high priority, layers 95-92 can be assigned a lower priority in order to maximize communications and compute overlap as better overlap can be achieved by issuing a certain layer's AllReduce at a later point in time. The messages of the different layers can also be prioritized to achieve better overall network utilization (not necessarily better job completion time).

Various embodiments of applications 1806 can provide indications or hints of priority level of data that is to be transmitted by NIC 1820. Accordingly, not all communication messages are equally important as some messages are to be received before other messages to reduce delays in data availability in a layer of a multi-layer NN system. As discussed herein, data can be processed in a particular order in a neural network and an ordering of data processing can influence priority of transmission of a data packet through a network and priority of transmission scheduling at NIC 1820. For example, back propagation ordering of messages having last in first out (LIFO) ordering dependency can cause the very last message to be issued to be a very first as content of the message is to be consumed in a next iteration. Additionally, with synchronous Stochastic Gradient Descent (SGD), iteration boundaries can function as hard barriers whereby communication of a given iteration must complete before the weight updates can be applied. Various embodiments provide for specification of communication dependencies using an overlap opportunity metric, which provides a measure of not only how much net communication time can be hidden behind compute and information about communication messages that are issued in the near future that are more important and/or susceptible to delays in a critical processing path.

In some embodiments, applications 1806 can assign a weight based on specific system and application conditions to determine a priority, where specific system and application conditions can include one or more of: static priority (e.g., the last layer is always most important), prioritization based on message size (e.g., smallest messages have higher priority), network congestion-based priority (e.g., messages that experience high congestion through a network to a receiver node are prioritized higher), or compute/communication-ratio-based prioritization (e.g., time spent to process data over time that data is expected to traverse a network to a next node).

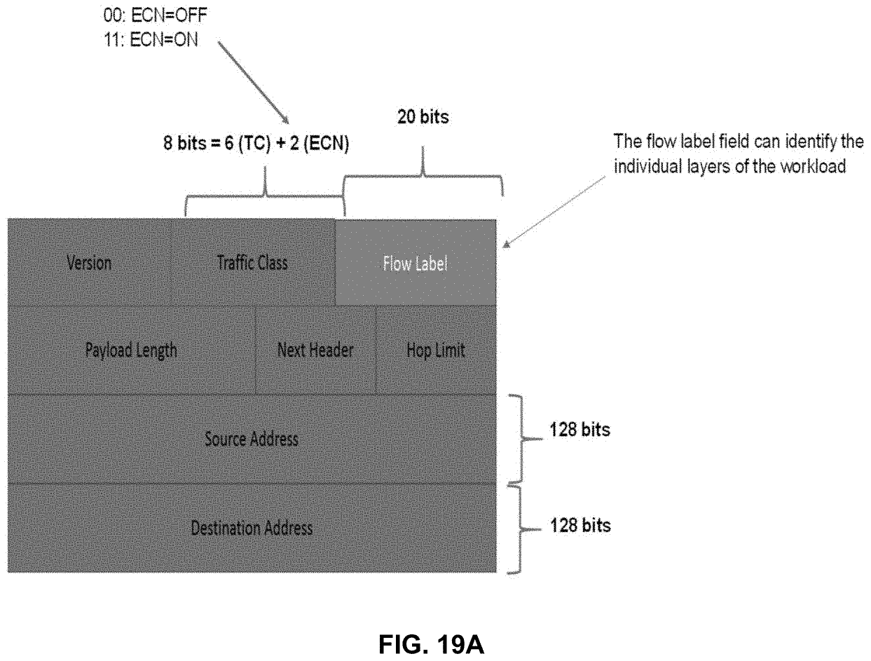

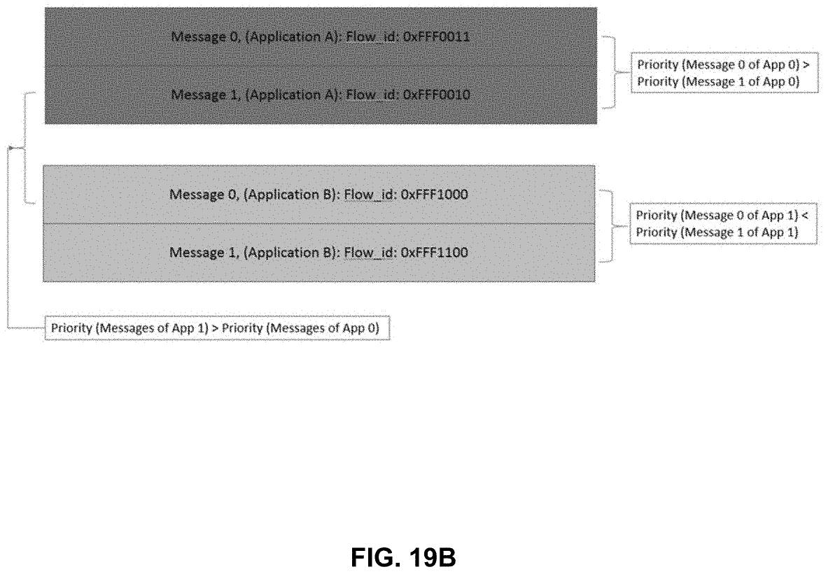

Applications 1806 can specify a priority level of a message using a Flow Label for inclusion in a packet as an indicator of Deadline-Awareness of certain application flows. For example, the Flow Label field in a Layer3 packet header (IPv6) can be used as an indicator of packet priority. For example, as shown in FIG. 19A, IPv6 includes a 20-bit field known as the flow label field (e.g., RFC 3697 (2004)) that enables per-flow differentiation at the IP layer. For example, the flow label field can identify the individual neural network layers of the workload. An IPv4 consistent packet can include an Identification field that is used to convey packet priority. In some examples, a virtual channel identifier (ID) field of a packet header can also be used to convey packet priority if there is QoS mapping of virtual channel ID to a priority level. Virtual channels (VCs) can be allocated for the highest deemed priority messages. Utilizing different VCs to achieve Quality-of-Service (QoS) levels can be used. The flow label value (or priority level) can be set by the source node and delivered unchanged to the destination node(s).

Hosts that do not support setting a Flow label field can set Flow label field to 0. Similarly, routers or switches that do not support Flow label field can ignore the state indicated and leave it unchanged when forwarding a packet.

The flow label field can be set with a numerical value, where the size of the value indicates the priority level (e.g. flow label field=1111 references a higher priority message than flow label field=0001). A sender NIC can choose to expose a limited number of priorities (e.g. 4 levels) to software (hence only needing to utilize 2-bits). Additionally, a NIC can choose to expose a certain number of bits to different applications in order to support prioritization of messages for both intra and inter-application.

A flow associated with each packet in some embodiments can be identified by examining an n-tuple in the header of each packet. The n-tuple in some embodiments includes L3 (e.g., Internet protocol (IP) layer) and L4 (e.g., transport layer) addresses of the packet, as well as the protocol used to communicate the packets. L3 addresses include the source IP address and the destination IP address of the packet. L4 addresses include source and destination transport port numbers.

A sender NIC (e.g., NIC 1820) can expose up to 2²⁰ levels of priority to a software framework or application or it can expose a reduced number of priority levels (e.g., 4 levels via 2 bits or other levels). Exposing a limited number of priority options to a given application can enable NIC 1820 to support prioritization across different applications. FIG. 19B provides an illustration of prioritization using 4 levels of priority exposed to an application.

NIC 1820 can support transmission and receipt of multiple traffic priority classes (e.g. virtual channels (VCs)). A driver (not shown) for NIC 1820 or OS 1808 can expose availability of NIC 1820 to support multiple priority levels. Applications 1806 can decide how to prioritize the different messages.

Various embodiments of applications 1806 can provide software hints to NIC 1820 to indicate a schedule of layers including activation functions of neural network such as a computational graph so that data provided for a particular layer can be prioritized based on order of processing among layers. An example of data processing is shown in FIG. 4. Based on a combination of software hints and network information from applications 1806 and network information from NIC 1820, NIC 1820 can determine message priority. For example, packet prioritization 1822 can prioritize packet priority and transmission scheduling based on software hints and/or network congestion. Packet prioritization 1822 can performed by NIC 1820 or applications 1806.

For embodiments of platform 1800 can be used to assign a priority data used in AI workloads and non-AI workloads. AI workload use-cases can include inference, training, or re-training. Non-AI workload use-cases can include at least storage traffic (e.g., NoSQL or SQL/relational databases), microservices, or web search. Non-AI workload use-cases can include non-timing critical workloads such as storage traffic (e.g., traffic that is in most cases utilize NoSQL Databases (e.g., Cassandra, MongoDB, Redis, etc.) that leverage eventual consistency semantics for storage). Eventual consistency implies consistency between reads/writes to a database are not guaranteed to be atomic, let alone between replicated copies. In some cases, if a replicated write to a NoSQL database is incrementally delayed, it is unlikely to alter any Service Level Agreements (SLAs) between providers and customers.

For an AI workload, inference can include at least near real time inference (e.g., imaging from a security camera to detect intruders, image detection for self-driving vehicle to decide vehicle control (e.g., stop, avoid, ignore)), or time insensitive inferences. Time insensitive inference can include at least non-real time inference (e.g., imaging from a camera to identify if an individual (or how many individuals) had entered a place of business or other time insensitive inferences.

Training can include at least configuring a recommendation engine (e.g., media suggestions) or collaborative filtering (e.g., identifying recommendations for users based on similar demographics such as age/gender/community or identifying recommendations for users based on similar interests or scenes). Training can include at least Bidirectional Encoder Representations from Transformers (BERT/alBERT) for Natural Language Processing (NLP), Deep Learning Recommendation (DLRM), Convolution Neural Networks (CNNs), or Reinforcement Neural Networks (RNNs). Re-training can include at least additional partial data-sets for the training models to process in order to improve accuracy.

In some cases, platform 1800 (e.g., applications 1806) can prioritize data transmitted for use in an AI workload over data transmitted for non-AI workloads. For example, four unique priority levels P0 to P3 can be utilized, where P0 is highest priority and P3 is a lowest priority. AI workloads or data can be assigned priorities P0-P1 and non-AI workloads or data assigned priorities P2-P3.

In some cases, prioritization of AI specific workloads can involve prioritizing certain AI applications over other AI applications. For example, real-time inference that necessitate time-critical reaction (e.g., threat-detection or vehicle collision avoidance) can be prioritized over training jobs (that execute over very large data-sets and take several iterations to converge to a solution). In this scenario, data used by real-time inference applications could be assigned a priority of P0 whereas data used by a training job could be assigned a lower priority (P3). Priority P1 and P2 can be left open for impromptu real-time or time-critical jobs.

A re-training job has already a model trained on a previous set of data, and is to update the model's accuracy with a new set of partial data. A partial new set of data may be smaller relative to the original trained dataset. In such cases, data used in a re-training job could be prioritized over data used in a full-fledged training job given the expected shorter duration of execution (e.g., Shortest Job First (SJF)) policy. However, a long job could be starved if many short re-training jobs are scheduled. In such case, the priority of data associated with newly scheduled re-training jobs could be de-prioritized (e.g., P2 or P3), and the long-training job could be elevated to P0-P1).

Data associated with non-real time inference operations can be assigned a priority level, but the priority level could decrease over time if an AI training job is starved (e.g., not receive data in packets quickly enough). Higher priority levels can be assigned to re-training jobs as long as full training jobs are being performed adequately fast. If full training jobs are not performed fast enough due to latency of packet receipt, some embodiments elevate priority of training job packets and de-prioritize priority of packets for re-training jobs.

Any application 1806 or source network interface 1820 can identify data of an AI workload and a source network interface 1820 can identify the AI workload in a packet using Flow Label such as using 1 bit or multiple bits and identify a non-AI workload in a packet using Flow Label such as using 1 bit or multiple bits. Any application 1806 or source network interface 1820 can identify a priority level of data of an AI workload and a source network interface 1820 can identify the priority level of data of the AI workload in a packet using Flow Label such as using 1 bit or multiple bits and identify a priority level of data of a non-AI workload in a packet using Flow Label such as using 1 bit or multiple bits. Any network device (e.g., source network interface, switch (e.g., switch in a path to an endpoint receiver or an endpoint receiver), router (e.g., router in a path to an endpoint receiver or an endpoint receiver), or destination network interface) can prioritize packets identified as AI workloads in terms of forwarding table utilization, queue space, packet egress, or packet processing pipeline configuration.

Any switch or NIC 1820 in conjunction with any switch or endpoint NIC could dynamically utilize prioritization for one or more of the packet transmission or processing prioritization or routing decisions. In some examples, NIC 1820 can assign messages to a higher priority VC if the Flow Label indicates a packet is higher priority. A higher priority of a packet can provide for sooner transmission scheduling and priority of traversal through network to its destination and sooner availability to a host computing system at the destination node. Examples of a flow label field are described earlier. In some cases, NIC 1820 can assign packets of high priority to an unused VC so that packets of an AI training application can use a particular VC to allow additional bandwidth via switch arbitration policies.

In some cases, a switch (e.g., S0, S1, or S2) can perform VC allocation (e.g., strict bypass) so that packets of critical message start on VC0 (default), but if congestion is encountered mid network traversal, the switch can adjust the VC of the packets to provide VC bypass so packets can use a less congested virtual buffer. In some cases, a switch can apply dynamic strict VC bypass whereby packets marked with a higher priority can be moved to a different VC if they incur congestion during routing. VC adjustment may be performed one or more times for a route. Packets in the VC bypass may or may not be permitted to use a previously used VC or a different VC. Assignment of VCs can utilize a routing scheme whereby a group of VC bypass can be used as a virtual network. For example, a switch can perform VC bypass if upon packet arrival, a given input-port or VC queue depth is significantly large.

The VC allocation (e.g., strict bypass or VC bypass) could attempt to avoid a congested VC. The VC allocation (e.g., strict bypass or VC bypass) could be made as soon as possible in a switch, for example, when the packet arrives into the ingress port. The VC allocation can be determined in a routing decision when the packet is pushed into the egress queues.

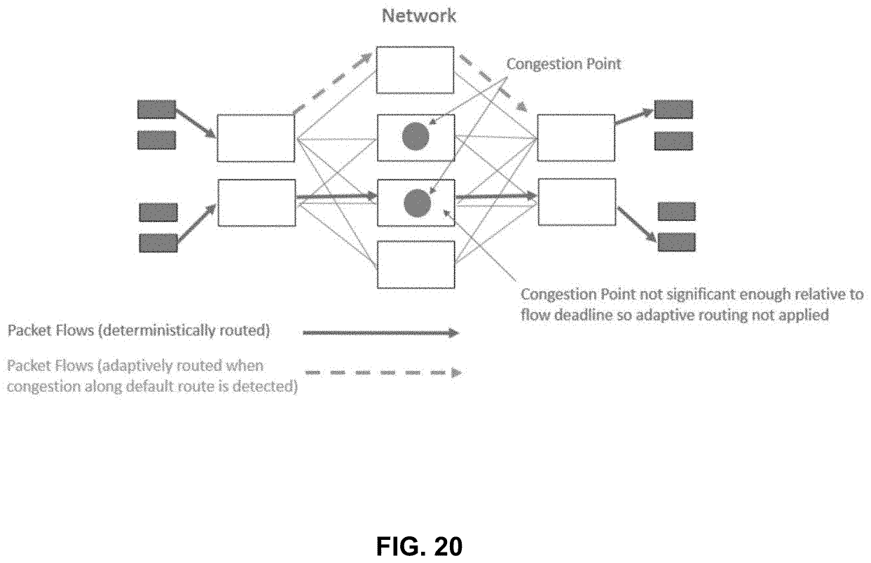

In some examples, a sender NIC (e.g., NIC 1820) can utilize source-based adaptive routing of packets with higher priority to different paths if a default path is paused (e.g., due to PFC or PAUSE frames) or severely congested. A sender NIC can selectively perform adaptive routing to mitigate hindrance of having too many Out-Of-Order (OOO) packets to which certain end-host congestion protocols. For example, FIG. 20 depicts an example of adaptive routing applied to a flow's packets in the presence of network congestion that will cause flow to miss specified deadline.

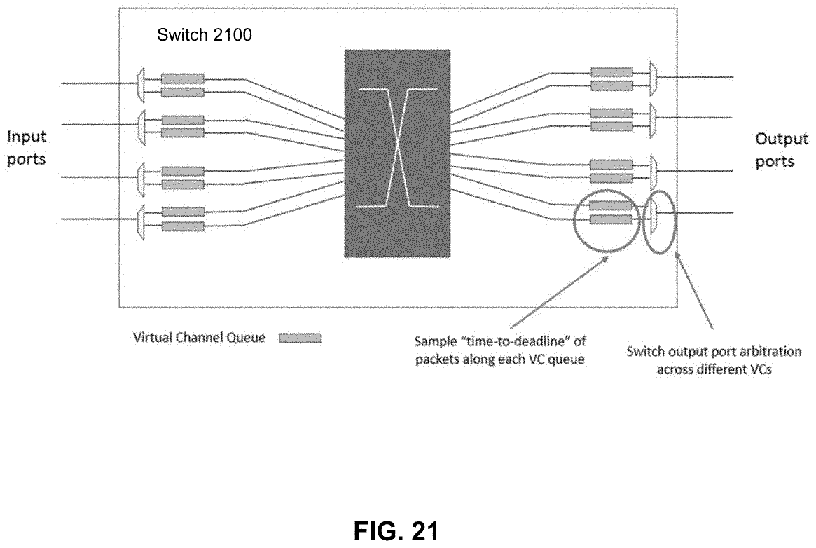

FIG. 21 depicts an example of monitoring of different VC queues of a switch's output port. Over time, the arbitration weight applied to each VC could dynamically be adjusted to better ensure packet ejection is prioritized relative to indicated deadline. In some examples, switch 2100 is programmable (e.g., P4 programmability such as Intel® Tofino™ switch, or programmability using C, Python, or OpenDataPlane (ODP)) can provides flexibility to monitor and adjust certain performance characteristics of a switch. Some embodiments implement match-actions in P4 programing language, which is a programming language designed to allow programming of packet forwarding in data-planes. In some examples, to reduce reduction in packet traversal below line-rate, not every packet's priority is monitored or extracted and dynamic monitoring of in-flight packets can be performed to determine the average priority of the packets (e.g., determined from the packet's flow label field) queued at a particular VC of a given output port. If a VC transmits higher priority packets relative to another VC, then the former output VC can be given additional transmission bandwidth. For instance, the switch can adjust the weights of the Weighted Round-Robin (WRR) in the switch arbitration scheme. For instance, the ‘W’ portion of WRR can be dynamically increased over time if a switch observes that the priority of the packets flowing are increasing over time, or ‘W’ can be slowly decreased back to default if the priority level decreases. In some examples, transmission bandwidth associated with a VC can be adjusted via adjustment of the ‘W’ factor. In some examples, an arbitration technique can be applied at any input port of switch 2100.

Some packets may be received out of order (OOO) from transmission. To reduce the degree of OOO receipt of packets at a switch or endpoint receiver, techniques can be used such as: utilization of a congestion control (CC) Protocol and Reliability mechanism that are tolerant to high degrees of packet reordering, selective use of VC bypass (described earlier) or coarse-grain level re-routing, such as per-flow (e.g., Erico Vanini, Rong Pan, Mohammad Alizadeh, Parvin Taheri and Tom Edsall. 2017. Let It Flow: Resilient Asymmetric Load Balancing with Flowlet Switching. 14th USENIX Symposium on Networked Systems Design and Implementation (NSDI 17). USENIX association, Boston, Mass., USA, 407-420) or on a per-message basis.

Referring again to FIG. 18, NIC 1820 can provide communications using one or more of Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), Infinity Fabric (IF), 3GPP Long Term Evolution (LTE) (4G), 3GPP 5G, and variations thereof. In some examples, data can be copied or stored to virtualized storage nodes using protocols such as Non-Volatile Memory Express (NVMe) or NVMe over fabrics (NVMe-oF) (or iSCSI storage command generation). For example, NVMe-oF is described at least in NVM Express, Inc., “NVM Express Over Fabrics,” Revision 1.0, Jun. 5, 2016, and specifications referenced therein and variations and revisions thereof.

Network 1850 can include at least switches S0, S1, and S2 to provide communication with other network elements and computing platforms. Any switch can provide Explicit Congestion Notification (ECN) Marking in an acknowledgement (ACK) or any congestion indications described herein to NIC 1820. Any switch can perform Adaptive Routing (e.g., Random Packet Spray) or Dynamic Arbitration Policy when servicing packets/flows from different VCs to adjust a path of a packet to a destination to avoid congested nodes. Any switch can be programmable using P4 or other schemes to adjust arbitration policy over time. Any computing platform 1800-1 to 1800-N can receive packets from NIC 1820. Any computing platform 1800-1 to 1800-N can transmit ML data in packets to computing platform 1800-0 in a similar manner as that described with respect to computing platform 1800-0. In some examples, computing platforms 1800-0 to 1800-N are within a same server or rack of servers, among different racks, or within different data centers or edge nodes.

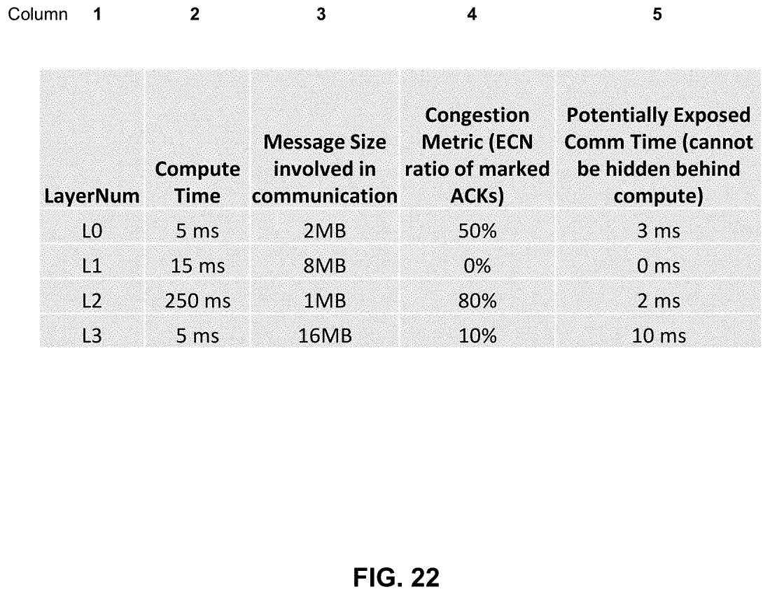

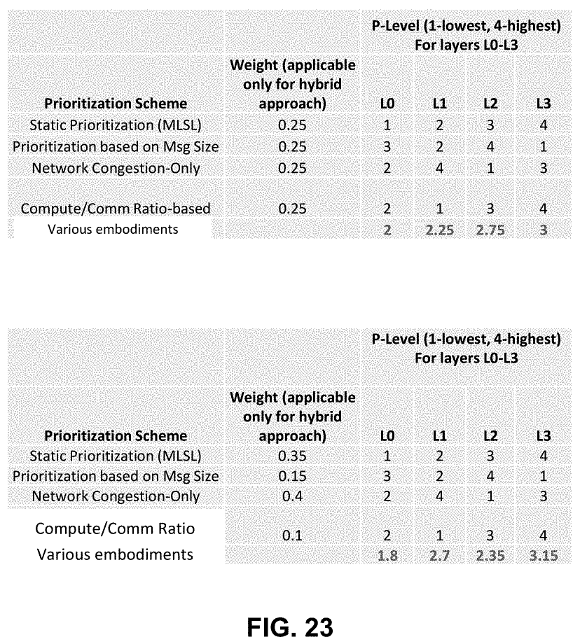

According to some embodiments, a computing platform can apply prioritization schemes depicted in FIGS. 22 and 23 that can be used at least in data parallelism or model parallelism models. In the example of FIG. 22, an example neural network with 4 layers is used (e.g., layers L0-L3), but fewer or more layers can be supported. Messages can be sent for processing by a next sequential layer. Note that messages can be sent for processing by the same layer in a subsequent iteration. For example, a message from L0 in iteration i can be provided to layer L0 in iteration i+1. Column 1 shows layer numbers L0 to L3. As shown in Columns 2 and 3, a layer can have an associated compute time and communication message size. Compute time can be an amount of time a compute at a layer is expected to take to complete and can incorporate communication time of a message to be processed by the layer from an earlier layer or the same layer number. Communication time of a message can depend on message size, node traversal, number of switches, network congestion, and so forth. In other words, for a layer, compute can be expected to complete after a starting time but the compute may finish before or after the expected completion time. Column 4 shows example congestion levels in a network of devices between a data producer node and a data consumer node for one or more layers (e.g., sequential layers or same layer during subsequent iterations). A congestion metric can represent an instantaneous or average level of congestion between a data producer node and a data consumer node.

Column 5 shows potential communication (Comm) time that is exposed (e.g., system stalls waiting for an operation by a layer to complete). If a message is not available at an expected start of compute for a layer due to network latency or other factors, a delay in compute completion may result, as indicated by a time value in Column 5. A non-zero time value in Column 5 can represent a time over an expected time to complete computation. Various embodiments can attempt to prioritize messages that are expected to experience a higher value in Column 5.

FIG. 23 shows examples of assigning priorities to layers based on weighing characteristics of a neural network with 4 layers (e.g., layers L0-L3). Static prioritization can refer to an order of layer completion. Prioritization based on message (Msg) size can refer to prioritization based on an expected message size sent by a particular layer. Prioritization based on network congestion can be based on an amount of congestion experienced between a layer and a subsequent layer so that a highest congestion level corresponds to a highest priority level and a lowest congestion level corresponds to a lowest priority level. For example, compute/comm ratio can refer to a ratio of (compute time allocated to a layer)/(expected time for communication of the previous layer to complete and be provided to the layer through a network).

In some examples, a software framework (e.g., ML application) can assign the weight of prioritization level of each factor. The software framework can determine computational graph dependencies of the neural network and receive feedback of network congestion to have data on a system level view of the workload. Message priority from a layer can be assigned based on weighing various prioritization schemes to derive a combined priority. In some examples, equal weights are applied to a prioritization level of each factor whereas in some examples, different weightings are applied to a prioritization level of each factor. An administrator or machine learning algorithm can be used to determine which weights provide the least time amount of processing stalls due to unavailability of data (e.g., data from a prior layer not being available for processing by a current layer).

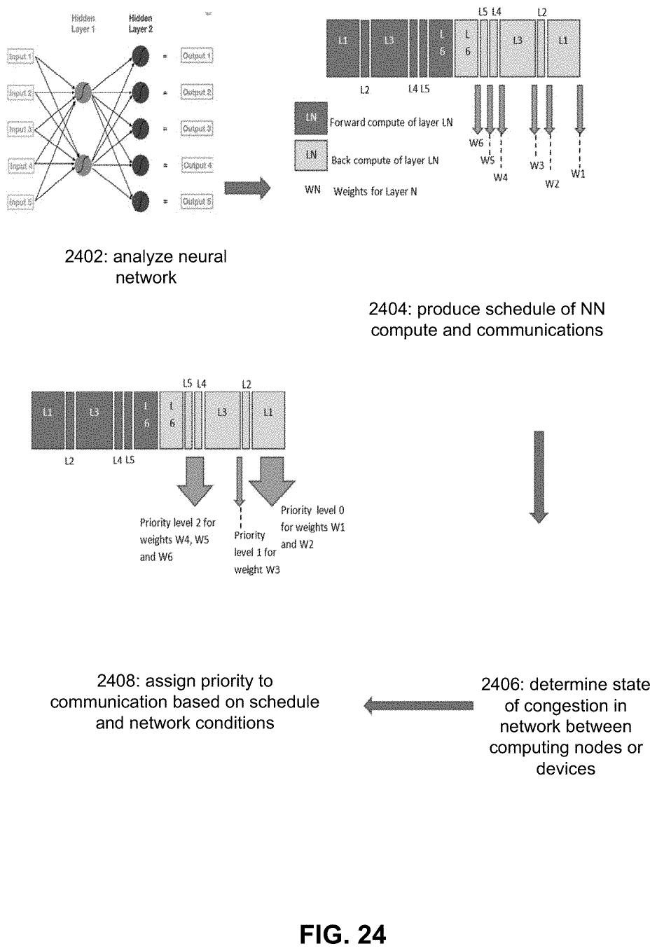

FIG. 24 depicts an example manner to assign message priority by combining a workload-level view from software with network feedback on current congestion. At 2402, software (e.g., ML application) can analyze a neural network and at 2404, provide a schedule of compute and communications in the neural network based on layer orderings including forward and backward compute operations. At 2406, software (e.g., application and/or communications interface) and/or a NIC can determine congestion in a network between compute nodes based on various factors described herein. At 2408, a priority can be assigned to a communication based on at least on a schedule of compute operations and communications in the neural network and network congestion. The priority can be embedded in a packet (e.g., header) to indicate a priority of the packet to switches and endpoint devices so that the switches and endpoint devices provide appropriate packet processing and re-transmission priority to the packet. In some examples, a Flow Label can be used to indicate priority level.

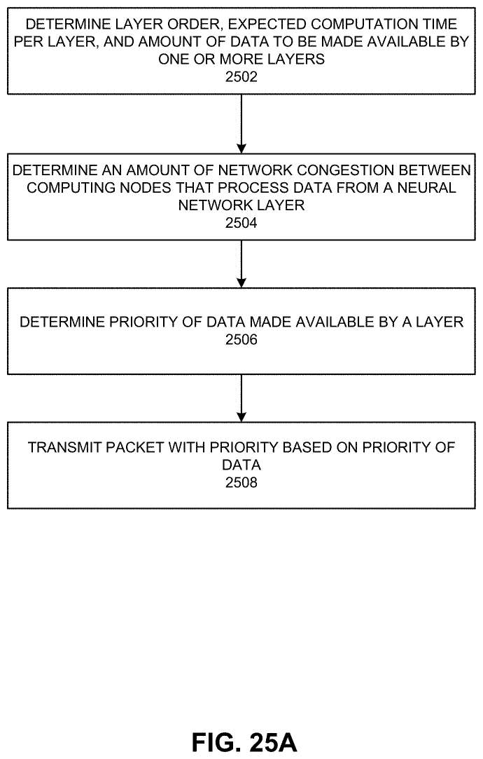

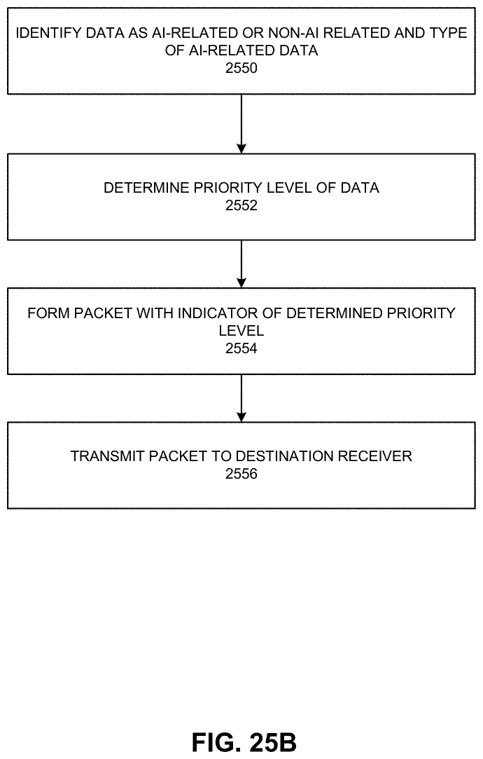

FIG. 25A depicts an example process. The process can be performed at a computing node to prioritize data transmission in connection with execution of a neural network on multiple nodes using data parallelism or model parallelism. At 2502, a layer order, computation time for each layer, and amount of data to be sent for one or more layers of a neural network can be determined. For example, a machine learning application, communication interface, and/or NIC can determine one or more of: layer order, computation time for each layer, and amount of data to be sent for each layer. At 2504, an amount of network congestion or latency between a sender node and a receiver node can be determined. For example, the sender node and a receiver node can perform computation for successive layers of a neural network. The network congestion or latency can be determined for two or more successive layers. In some examples, a communications interface or NIC can determine network congestion or latency between layers.

At 2506, a machine learning application can determine a priority level of data made available by a layer. For example, priority of a message sent by a layer can be based on one or more of: layer order, computation time for each layer, amount of data to be sent for each layer, and network congestion or expected time a message is inflight between a sender node and receiver node. In some examples, factors such as layer order, computation time for each layer, amount of data to be sent for each layer, and network congestion can be given equal weighting in determining priority of a message sent from a layer whereas in other examples, factors are given the same or varying weights. At 2508, a priority of a packet that carries a message of the neural network based on the priority level can be set. For example, an application can specify a priority level of a message and a NIC can insert the priority level into a header of a packet that conveys the message and/or assign a particular virtual channel or traffic class to the packet. The priority level and/or virtual channel or traffic class can be used to prioritize packet processing and/or packet re-transmission by network elements or endpoint devices.

FIG. 25B depicts an example process. The process can be performed at a computing node to prioritize data transmission in connection with providing data (e.g., weights, files, numerical values) from one node to another node. At 2550, data can be identified as AI-related or non-AI related and a type of AI-related data. A type of AI-related data can be identified as inference, training, or re-training. For inference, the data can be identified as for use in real-time or non-time sensitive inference.

At 2552, a priority of the data can be set based on whether the data is AI-related or non-AI related and a type of AI-related data. For example, AI-related data can be prioritized over non-AI data. For example, AI-related data that is used for inference can be prioritized over AI-related data that is used for training or re-training. For example, AI-related data that is used for time sensitive inference can be prioritized over AI-related data that is used for non-time sensitive inference. In some examples, an application can specify whether data is AI-related or non-AI related and a type of AI-related data.

In some examples, a priority level associated with a particular AI inference operation may decrease over time given pressure from AI training jobs to reduce packet transfer latency. For example, a priority level of data associated with a non-real time inference operation can be reduced and a priority level of data associated with an AI training job that is progressing too slowly due to packet transfer latency can be increased.

At 2554, a packet can be formed with an indicator of the determined priority level. For example a Flow Label field can be used to convey the priority level. In some examples, a network interface controller can form the packet with the indicator of the determined priority level. At 2556, the packet can be transmitted to a destination receiver. In some examples, a network interface controller can transmit the packet to a destination receiver through a path of zero or more intermediary network devices. In some examples, an intermediary network device (e.g., switch or router) can read the priority level and can allocate resources (e.g., packet processing, buffer space, egress scheduling) based on the priority level. For example, a packet with a highest priority level can be allocated resources that allow the packet to be processed most rapidly and/or egress the intermediary network device most rapidly.

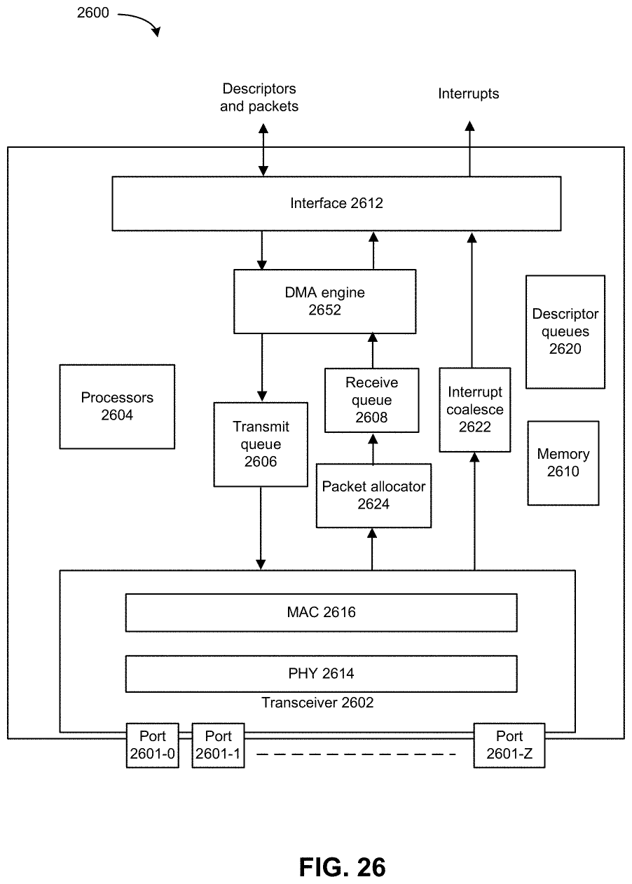

FIG. 26 depicts an example of a network interface. Various embodiments of the network interface can perform embodiments described herein to prioritize packet transmission based on data dependencies and network congestion. Transceiver 2602 can be capable of receiving and transmitting packets using various ports 2601-0 to 2601-Z in conformance with the applicable protocols such as Ethernet as described in IEEE 802.3, although other protocols may be used. Transceiver 2602 can receive and transmit packets from and to a network via a network medium (not depicted). A network medium can be a wired or wireless medium. A wired medium can conduct electrical and/or optical signals. For example, a medium can be any type of cable such as but not limited to optical fiber (e.g., 25GBASE-SX, 25GBASE-LX, 1000BASE-X, 1000BASE-SX, 1000BASE-LX, 1000BASE-BX, 1000BASE-RHx, or 1000BASE-PX), twisted pair cable (e.g., 1000BASE-T, 1000BASE-T1, 1000BASE-TX), shielded balanced copper cable (e.g., 1000BASE-CX), copper backplane (e.g., 1000BASE-KX), as well as other speeds (e.g., 10 Gbps). In some examples, a network interface can include one or more of: a network interface card, network interface controller, a host fabric interface (HFI), a host bus adapter (HBA), network interface connected to a bus or connection (e.g., PCIe, CXL, DDR, and so forth). Network interface and CPU can be built as Multi-Chip-Packages (MCP), System-On-Chip (SoC) or as combination of MCP/SoC and discrete devices connected over PCIe bus.

Some examples of network device are part of an Infrastructure Processing Unit (IPU) or data processing unit (DPU). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Transceiver 2602 can include PHY circuitry 2614 and media access control (MAC) circuitry 2616. PHY circuitry 2614 can include encoding and decoding circuitry (not shown) to encode and decode data packets according to applicable physical layer specifications or standards. MAC circuitry 2616 can be configured to perform MAC address filtering on received packets, process MAC headers of received packets by verifying data integrity, remove preambles and padding, and provide packet content for processing by higher layers. MAC circuitry 2616 can be configured to assemble data to be transmitted into packets, that include destination and source addresses along with network control information and error detection hash values.

Processors 2604 and packet processing circuitry can include any combination of a: processor, core, graphics processing unit (GPU), field programmable gate array (FPGA), application specific integrated circuit (ASIC), or other programmable hardware device that allow programming of network interface 2600. For example, a “smart network interface” can provide packet processing capabilities in the network interface using processors 2604.

Packet allocator 2624 can provide distribution of received packets for processing by multiple CPUs or cores using timeslot allocation described herein or RSS. When packet allocator 2624 uses RSS, packet allocator 2624 can calculate a hash or make another determination based on contents of a received packet to determine which CPU or core is to process a packet.

Interrupt coalesce 2622 can perform interrupt moderation whereby network interface interrupt coalesce 2622 waits for multiple packets to arrive, or for a time-out to expire, before generating an interrupt to host system to process received packet(s). Receive Segment Coalescing (RSC) can be performed by network interface 2600 whereby portions of incoming packets are combined into segments of a packet. Network interface 2600 provides this coalesced packet to an application.

Direct memory access (DMA) engine 2652 can copy a packet header, packet payload, and/or descriptor directly from host memory to the network interface or vice versa, instead of copying the packet to an intermediate buffer at the host and then using another copy operation from the intermediate buffer to the destination buffer.

Memory 2610 can be any type of volatile or non-volatile memory device and can store any queue or instructions used to program network interface 2600. Transmit queue 2606 can include data or references to data for transmission by network interface. Receive queue 2608 can include data or references to data that was received by network interface from a network. Descriptor queues 2620 can include descriptors that reference data or packets in transmit queue 2606 or receive queue 2608. Bus interface 2612 can provide an interface with host device (not depicted). For example, bus interface 2612 can be compatible with PCI, PCI Express, PCI-x, Serial ATA, and/or USB compatible interface (although other interconnection standards may be used).

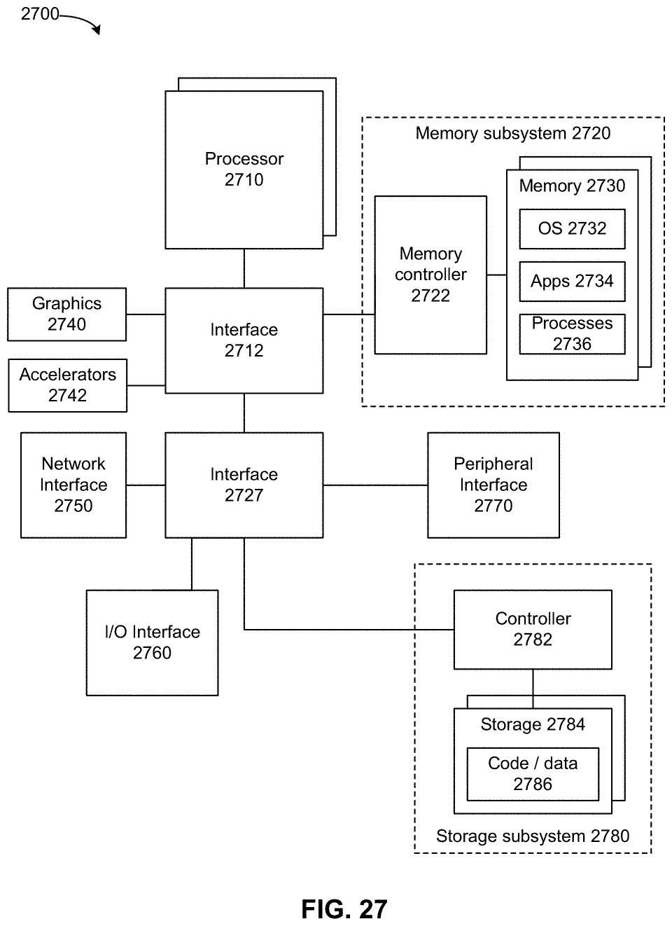

FIG. 27 depicts a system. Various embodiments can be used by system 2700 to perform machine learning training or inference using embodiments described herein. System 2700 includes processor 2710, which provides processing, operation management, and execution of instructions for system 2700. Processor 2710 can include any type of microprocessor, central processing unit (CPU), graphics processing unit (GPU), processing core, or other processing hardware to provide processing for system 2700, or a combination of processors. Processor 2710 controls the overall operation of system 2700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 2700 includes interface 2712 coupled to processor 2710, which can represent a higher speed interface or a high throughput interface for system components that needs higher bandwidth connections, such as memory subsystem 2720 or graphics interface components 2740, or accelerators 2742. Interface 2712 represents an interface circuit, which can be a standalone component or integrated onto a processor die. Where present, graphics interface 2740 interfaces to graphics components for providing a visual display to a user of system 2700. In one example, graphics interface 2740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 2740 generates a display based on data stored in memory 2730 or based on operations executed by processor 2710 or both. In one example, graphics interface 2740 generates a display based on data stored in memory 2730 or based on operations executed by processor 2710 or both.

Accelerators 2742 can be a fixed function or programmable offload engine that can be accessed or used by a processor 2710. For example, an accelerator among accelerators 2742 can provide compression (DC) capability, cryptography services such as public key encryption (PKE), cipher, hash/authentication capabilities, decryption, or other capabilities or services. In some embodiments, in addition or alternatively, an accelerator among accelerators 2742 provides field select controller capabilities as described herein. In some cases, accelerators 2742 can be integrated into a CPU socket (e.g., a connector to a motherboard or circuit board that includes a CPU and provides an electrical interface with the CPU). For example, accelerators 2742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 2742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 2720 represents the main memory of system 2700 and provides storage for code to be executed by processor 2710, or data values to be used in executing a routine. Memory subsystem 2720 can include one or more memory devices 2730 such as read-only memory (ROM), flash memory, one or more varieties of random access memory (RAM) such as DRAM, or other memory devices, or a combination of such devices. Memory 2730 stores and hosts, among other things, operating system (OS) 2732 to provide a software platform for execution of instructions in system 2700. Additionally, applications 2734 can execute on the software platform of OS 2732 from memory 2730. Applications 2734 represent programs that have their own operational logic to perform execution of one or more functions. Processes 2736 represent agents or routines that provide auxiliary functions to OS 2732 or one or more applications 2734 or a combination. OS 2732, applications 2734, and processes 2736 provide software logic to provide functions for system 2700. In one example, memory subsystem 2720 includes memory controller 2722, which is a memory controller to generate and issue commands to memory 2730. It will be understood that memory controller 2722 could be a physical part of processor 2710 or a physical part of interface 2712. For example, memory controller 2722 can be an integrated memory controller, integrated onto a circuit with processor 2710.

In some examples, OS 2732 can determine a capability of a device associated with a device driver. For example, OS 2732 can receive an indication of a capability of a device (e.g., network interface 2750) to apply prioritization of machine learning data. OS 2732 can request a driver to enable or disable network interface 2750 to perform any of the capabilities described herein. In some examples, OS 2732, itself, can enable or disable network interface 2750 to perform any of the capabilities described herein. OS 2732 can provide requests (e.g., from an application or VM) to network interface 2750 to utilize one or more capabilities of network interface 2750. For example, any application can request use or non-use of any of capabilities described herein by network interface 2750.

While not specifically illustrated, it will be understood that system 2700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 2700 includes interface 2714, which can be coupled to interface 2712. In one example, interface 2714 represents an interface circuit, which can include standalone components and integrated circuitry. In one example, multiple user interface components or peripheral components, or both, couple to interface 2714. Network interface 2750 provides system 2700 the ability to communicate with remote devices (e.g., servers or other computing devices) over one or more networks. Network interface 2750 can include an Ethernet adapter, wireless interconnection components, cellular network interconnection components, USB (universal serial bus), or other wired or wireless standards-based or proprietary interfaces. Network interface 2750 can transmit data to a device that is in the same data center or rack or a remote device, which can include sending data stored in memory. Network interface 2750 can receive data from a remote device, which can include storing received data into memory. Various embodiments can be used in connection with network interface 2750, processor 2710, and memory subsystem 2720. Various embodiments of network interface 2750 use embodiments described herein to receive or transmit timing related signals and provide protection against circuit damage from misconfigured port use while providing acceptable propagation delay.

In one example, system 2700 includes one or more input/output (I/O) interface(s) 2760. I/O interface 2760 can include one or more interface components through which a user interacts with system 2700 (e.g., audio, alphanumeric, tactile/touch, or other interfacing). Peripheral interface 2770 can include any hardware interface not specifically mentioned above. Peripherals refer generally to devices that connect dependently to system 2700. A dependent connection is one where system 2700 provides the software platform or hardware platform or both on which operation executes, and with which a user interacts.

In one example, system 2700 includes storage subsystem 2780 to store data in a nonvolatile manner. In one example, in certain system implementations, at least certain components of storage 2780 can overlap with components of memory subsystem 2720. Storage subsystem 2780 includes storage device(s) 2784, which can be or include any conventional medium for storing large amounts of data in a nonvolatile manner, such as one or more magnetic, solid state, or optical based disks, or a combination. Storage 2784 holds code or instructions and data 2786 in a persistent state (i.e., the value is retained despite interruption of power to system 2700). Storage 2784 can be generically considered to be a “memory,” although memory 2730 is typically the executing or operating memory to provide instructions to processor 2710. Whereas storage 2784 is nonvolatile, memory 2730 can include volatile memory (i.e., the value or state of the data is indeterminate if power is interrupted to system 2700). In one example, storage subsystem 2780 includes controller 2782 to interface with storage 2784. In one example controller 2782 is a physical part of interface 2714 or processor 2710 or can include circuits or logic in both processor 2710 and interface 2714.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version 3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 2700. More specifically, power source typically interfaces to one or multiple power supplies in system 2700 to provide power to the components of system 2700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 2700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

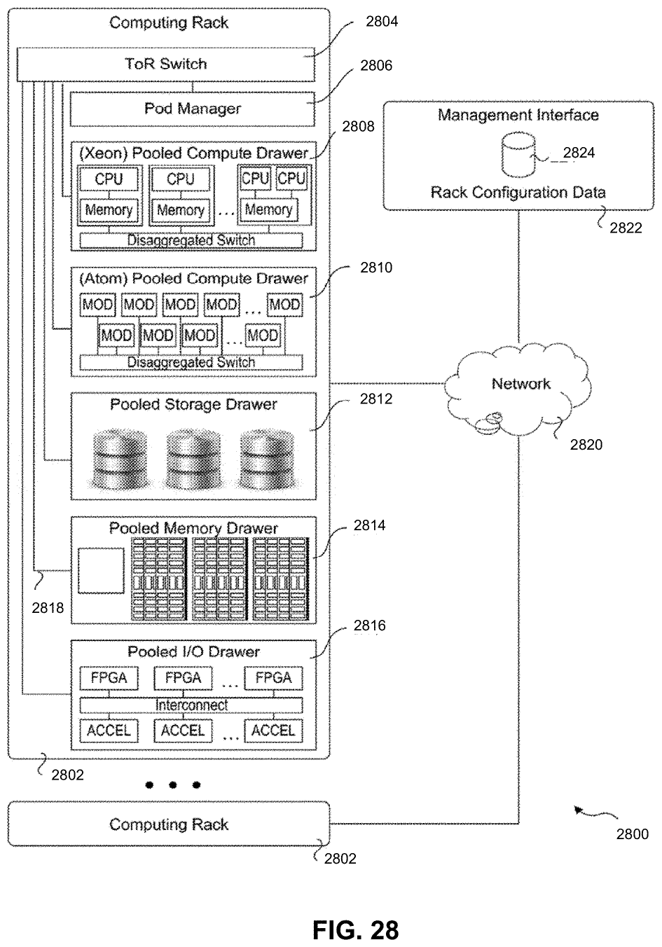

FIG. 28 depicts an environment 2800 includes multiple computing racks 2802, each including a Top of Rack (ToR) switch 2804, a pod manager 2806, and a plurality of pooled system drawers. The environment can provide packet prioritization in accordance with embodiments described herein. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® Xeon® processor pooled computer drawer 2808, and Intel® ATOM™ processor pooled compute drawer 2810, a pooled storage drawer 2812, a pooled memory drawer 2814, and a pooled I/O drawer 2816. Each of the pooled system drawers is connected to ToR switch 2804 via a high-speed link 2818, such as an Ethernet link and/or a Silicon Photonics (SiPh) optical link.

Multiple of the computing racks 2802 may be interconnected via their ToR switches 2804 (e.g., to a pod-level switch or data center switch), as illustrated by connections to a network 2820. In some embodiments, groups of computing racks 2802 are managed as separate pods via pod manager(s) 2806. In one embodiment, a single pod manager is used to manage all of the racks in the pod. Alternatively, distributed pod managers may be used for pod management operations.

Environment 2800 further includes a management interface 2822 that is used to manage various aspects of the environment. This includes managing rack configuration, with corresponding parameters stored as rack configuration data 2824. In an example, environment 2800 can be implemented using interconnected compute sleds of processors, memories, storages, network interfaces, and other components.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example A includes assigning a priority level to a message that includes machine learning data based at least in part on a combination of a neural network layer order associated with the message and network congestion between a generator of the data and a second computing node that processes the data, wherein the priority level is to influence a priority of transmission of the message and processing of the message by one or more network elements.

Example B includes any example, wherein the layer order associated with the message comprises an identifier of which layer among multiple layers of the neural network is to generate the message.

Example C includes any example, wherein a last layer is assigned a highest priority.

Example D includes any example, wherein assigning a priority level to a message that includes machine learning data is based at least in part on an amount of data processing time at a particular layer, an amount of data to be transferred from the layer, and an expected network traversal time of the message.

Example E includes any example, wherein the network congestion is based on one or more of: round trip time (RTT), Bandwidth-Delay-Product (BDP), percentage of Explicit Congestion Notification (ECN) received in packet receipt acknowledgement (ACK) messages, Priority-based Flow Control (PFC), pause-based Xon/Xoff, Quantized Congestion Notification (QCN), IEEE 802.1 Congestion Notification Packet (CNP), in-network telemetry (INT), In-situ Operations, Administration, and Maintenance (IOAM) queue congestion information from a congested switch, or Time to live (TTL).

Example F includes any example, and includes a network interface setting a packet priority in an IP header field that is accessed and influences packet priority by intermediate network elements and receiver network interface, wherein the packet priority is based on the priority level.

Example G includes any example, wherein the IP header field comprises a flow label field in an IPv6 header.

Example H includes any example, and includes adjusting a path for a packet that carries the message to reduce transit time to a destination based on the network congestion.

Example 1 includes a method comprising: at a network device: accessing an indication in a packet of whether the packet includes machine learning data or non-machine learning data and allocating resources of the network device based on the indication of whether the packet includes machine learning data or non-machine learning data.

Example 2 includes any example, wherein the indication in a packet of whether the packet includes machine learning data or non-machine learning data comprises a priority level and wherein one or more priority levels identify machine learning data.

Example 3 includes any example, wherein for machine learning data, the priority level is based on whether the machine learning data is associated with inference, training, or re-training operations and the priority level is based on whether the machine learning data is associated with real-time or time insensitive inference operations.

Example 4 includes any example, wherein for machine learning data, the priority level is based on whether a message is to be back propagated in a neural network.

Example 5 includes any example, wherein the resources of the network device comprise packet queues, packet processing resources, and egress scheduling priority.

Example 6 includes any example, wherein for machine learning data, the priority level is based on a neural network layer order in a machine learning model that is to process the machine learning data.

Example 7 includes any example, wherein the priority level is based on historic network congestion data between a generator of the machine learning data and a second computing node that processes the machine learning data.

Example 8 includes any example, wherein for machine learning data, the priority level is based on an amount of machine learning data processing time at a particular layer, an amount of machine learning data to be transferred from the layer, and an expected network traversal time of the machine learning data.

Example 9 includes any example, wherein the indication in a packet of whether the packet includes machine learning data or non-machine learning data comprises a Flow Label field in an IPv6 header.

Example 10 includes any example, wherein machine learning data is used by a neural network.

Example 11 includes any example, and includes adjusting a path for a packet that carries machine learning data or non-machine learning data to reduce transit time to a destination based on historic network congestion.

Example 12 includes any example, and includes a system comprising: a network interface and at least one processor to indicate whether data is associated with a machine learning operation or non-machine learning operation to manage traversal of the data through one or more network elements to a destination network element and cause the network interface to include an indication in a packet of whether the packet includes machine learning data or non-machine learning data.

Example 13 includes any example, wherein the indication in a packet of whether the packet includes machine learning data or non-machine learning data comprises a priority level and wherein one or more higher priority levels identify machine learning data.

Example 14 includes any example, wherein for machine learning data, the priority level is based on whether the data is associated with inference, training, or re-training operations.

Example 15 includes any example, wherein for machine learning data, the priority level is based on whether the data is associated with real-time or time insensitive inference operations.

Example 16 includes any example, wherein for machine learning data, the priority level is based on one or more of: a neural network layer order in a machine learning model that is to process the data, an amount of data processing time at a particular layer, an amount of data to be transferred from the layer, or an expected network traversal time of the data.

Example 17 includes any example, wherein the priority level is based on historic network congestion data between the network interface and a second computing node that processes the data.

Example 18 includes any example, wherein the indication in a packet of whether the packet includes machine learning data or non-machine learning data comprises a Flow Label field in an IPv6 header.

Example 19 includes any example, wherein the network interface is to adjust a path for a packet that carries the data to reduce transit time to a destination based on historic network congestion.

Example 20 includes any example, and includes one or more of a server, rack, or data center, wherein the server, rack, or data center is to provide the data to be transmitted in the packet or access the data transmitted using the packet.

Example 21 includes any example, and includes a computer-readable medium, comprising instructions stored thereon, that if executed by at least one processor, cause the at least one processor to: assign a priority level to a message to indicate whether the message includes machine learning data or non-machine learning data to influence a priority of transmission of the message and processing of the message by one or more network elements.

Example 22 includes any example, wherein the indication in a packet of whether the packet includes machine learning data or non-machine learning data comprises a priority level and wherein one or more priority levels identify machine learning data.

Example 23 includes any example, wherein for machine learning data, the priority level is based on whether the machine learning data is associated with inference, training, or re-training operations.

What is claimed is:

1. A method comprising:
at a network device:
accessing an indication in a packet of whether the packet includes machine learning data or non-machine learning data and
allocating resources of the network device based on the indication of whether the packet includes machine learning data or non-machine learning data.

2. The method of claim 1, wherein the indication in a packet of whether the packet includes machine learning data or non-machine learning data comprises a priority level and wherein one or more priority levels identify machine learning data.

3. The method of claim 2, wherein for machine learning data, the priority level is based on whether the machine learning data is associated with inference, training, or re-training operations and the priority level is based on whether the machine learning data is associated with real-time or time insensitive inference operations.

4. The method of claim 2, wherein for machine learning data, the priority level is based on whether a message is to be back propagated in a neural network.

5. The method of claim 1, wherein the resources of the network device comprise packet queues, packet processing resources, and egress scheduling priority.

6. The method of claim 3, wherein for machine learning data, the priority level is based on a neural network layer order in a machine learning model.

7. The method of claim 3, wherein the priority level is based on historic network congestion data between a generator of the machine learning data and a second computing node that processes the machine learning data.

8. The method of claim 3, wherein for machine learning data, the priority level is based on an amount of machine learning data processing time at a particular layer, an amount of machine learning data to be transferred from the layer, and an expected network traversal time of the machine learning data.

9. The method of claim 1, wherein the indication in a packet of whether the packet includes machine learning data or non-machine learning data comprises a Flow Label field in an IPv6 header.

10. The method of claim 1, wherein machine learning data is used by a neural network.

11. The method of claim 1, comprising:
adjusting a path for a packet that carries machine learning data or non-machine learning data to reduce transit time to a destination based on historic network congestion.

12. A system comprising:
a network interface and
at least one processor to
indicate whether data is associated with a machine learning operation or non-machine learning operation to manage traversal of the data through one or more network elements to a destination network element and
cause the network interface to include an indication in a packet of whether the packet includes machine learning data or non-machine learning data.

13. The system of claim 12, wherein the indication in a packet of whether the packet includes machine learning data or non-machine learning data comprises a priority level and wherein one or more higher priority levels identify machine learning data.

14. The system of claim 13, wherein for machine learning data, the priority level is based on whether the data is associated with inference, training, or re-training operations.

15. The system of claim 13, wherein for machine learning data, the priority level is based on whether the data is associated with real-time or time insensitive inference operations.

16. The system of claim 13, wherein for machine learning data, the priority level is based on one or more of: a neural network layer order in a machine learning model that is to process the data, an amount of data processing time at a particular layer, an amount of data to be transferred from the layer, or an expected network traversal time of the data.

17. The system of claim 13, wherein the priority level is based on historic network congestion data between the network interface and a second computing node that processes the data.

18. The system of claim 12, wherein the indication in a packet of whether the packet includes machine learning data or non-machine learning data comprises a Flow Label field in an IPv6 header.

19. The system of claim 12, wherein the network interface is to adjust a path for a packet that carries the data to reduce transit time to a destination based on historic network congestion.

20. The system of claim 12, comprising one or more of a server, rack, or data center, wherein the server, rack, or data center is to provide the data to be transmitted in the packet or access the data transmitted using the packet.

21. A computer-readable medium, comprising instructions stored thereon, that if executed by at least one processor, cause the at least one processor to:
assign a priority level to a message to indicate whether the message includes machine learning data or non-machine learning data to influence a priority of transmission of the message and processing of the message by one or more network elements.

22. The computer-readable medium of claim 21, wherein the indication in a packet of whether the packet includes machine learning data or non-machine learning data comprises a priority level and wherein one or more priority levels identify machine learning data.

23. The computer-readable medium of claim 22, wherein for machine learning data, the priority level is based on whether the machine learning data is associated with inference, training, or re-training operations.
